(19) United States
(12) Patent Application Publication
(10) Pub. No.: US 2026/0046184 A1
(43) Pub. Date: Feb. 12, 2026

(54) Communication Method and Communication Apparatus

(71) Applicant: HUAWEI TECHNOLOGIES CO., LTD., Shenzhen (CN)

(72) Inventors: Xiaojun Xi, Shenzhen (CN); Xiaoyan Bi, Shanghai (CN); Yong Liu, Shanghai (CN)

(73) Assignee: HUAWEI TECHNOLOGIES CO., LTD., Shenzhen (CN)

(21) Appl. No.: 19/363,247

(22) Filed: Oct. 20, 2025

Related U.S. Application Data
(63) Continuation of application No. PCT/CN2023/089877, filed on Apr. 21, 2023.

(51) Int. Cl. H04L 27/26; H04B 17/309; H04W 72/0453

(52) U.S. Cl. CPC H04L 27/261; H04B 17/346; H04W 72/0453

(57) ABSTRACT

In a method, a first apparatus may determine a frequency domain position and a transmit antenna port of a reference signal based on a channel noise constraint condition, so that a position of the reference signal follows specific regularity. The first apparatus indicates the frequency domain position and the transmit antenna port of the reference signal to a second apparatus.

### CROSS-REFERENCE TO RELATED APPLICATIONS

This is a continuation of International Patent Application No. PCT/CN2023/089877 filed on Apr. 21, 2023, the disclosure of which is hereby incorporated by reference in its entirety.

### TECHNICAL FIELD

This application relates to the field of communication technologies, and in particular, to a communication method and a communication apparatus.

### BACKGROUND

Currently, as antenna scales of a terminal device and a network device are greatly increased, and a quantity of physical ports is greatly increased, overheads of a reference signal for channel estimation are also greatly increased. Therefore, how to reduce overheads for reference signal indication in channel estimation is a problem worthy of attention.

### SUMMARY

This application provides a communication method and a communication apparatus. A position of a reference signal designed in the method follows specific regularity, to help reduce indication overheads of the reference signal. This helps reduce overheads of a sounding reference signal (SRS) for channel estimation, reduce a measurement delay, and improve accuracy of the channel estimation.

According to a first aspect, this application provides a communication method. The method is performed by a first apparatus. The first apparatus may be a network device, or may be a component (for example, a processor, a chip, or a chip system) of the network device, or may be a logical module that can implement all or a part of functions of the network device. The first apparatus determines a frequency domain position and a transmit antenna port of a reference signal based on a channel noise constraint condition. The first apparatus sends first indication information, where the first indication information indicates the frequency domain position and the transmit antenna port of the reference signal.

In the method, the first apparatus may determine the frequency domain position and the transmit antenna port of the reference signal based on the channel noise constraint condition, so that a position of the reference signal follows specific regularity, to help reduce indication overheads of the reference signal. The first apparatus indicates the frequency domain position and the transmit antenna port of the reference signal, to help reduce overheads of a sounding reference signal for channel estimation, reduce a measurement delay, and improve accuracy of the channel estimation.

In a possible implementation, the channel noise constraint condition includes a minimized channel noise-based reference signal selection criterion. Optionally, the channel noise constraint condition further includes a termination threshold that satisfies a minimum signal-to-noise ratio.

In a possible implementation, the channel noise constraint condition is associated with at least one or more of the following parameters: a quantity of receive antennas, a quantity of frequency domain subcarriers, power of a transmit end, noise power of a channel, and a lower limit of a received signal-to-noise ratio.

In a possible implementation, for example, that the first apparatus determines the frequency domain position and the transmit antenna port of the reference signal based on the channel noise constraint condition may be that the first apparatus determines the frequency domain position and the transmit antenna port of the reference signal based on one or more of parameters such as the quantity of receive antennas, the quantity of frequency domain subcarriers, the power of the transmit end, the noise power of the channel, and the lower limit of the received signal-to-noise ratio.

In the foregoing method, the first apparatus may further determine, based on a specific parameter associated with the channel noise constraint condition, a frequency domain position and a transmit antenna port that is of the reference signal and that satisfy the condition, so that a position of the reference signal follows specific regularity, to help reduce indication overheads of the reference signal.

In a possible implementation, frequency domain positions of the reference signal are partially continuous in a system bandwidth or a bandwidth part (BWP) allocated to a terminal device, and transmit antenna ports of the reference signal are partially continuous in a set including all transmit antenna ports.

In the method, a position of the reference signal follows specific regularity, to help reduce indication overheads of the reference signal. For example, the frequency domain positions of the reference signal are partially continuous in the system bandwidth (where it is assumed that no reference signal is designed at a part of frequency domain positions in the system bandwidth, and the reference signal is designed at other continuous frequency domain positions); or the transmit antenna ports of the reference signal are partially continuous in the set including all the transmit antenna ports (where it is assumed that no reference signal is designed at a part of all the transmit antenna ports, and the reference signal is designed at other continuously numbered antenna ports).

In a possible implementation, all frequency domain positions of the reference signal correspond to a same transmit antenna port.

In a possible implementation, some frequency domain positions of the reference signal correspond to a same transmit antenna port.

In the foregoing method, the antenna port and the frequency domain position follow specific regularity, to help reduce indication overheads of the reference signal. For example, assuming that all frequency domain positions of the reference signal correspond to transmit antenna ports with same numbers, the antenna port and the frequency domain position are regular; or if some frequency domain positions of the reference signal correspond to transmit antenna ports with same numbers, the antenna port and the frequency domain position may be considered to be regular.

In the implementation in which the first apparatus sends the first indication information, the first apparatus sends an index of a column vector of a second matrix in a first matrix or a third matrix to a second apparatus. The first matrix includes a part of frequency domain positions in the system bandwidth, a part of transmit antenna ports, and all receive antenna ports, and the part of frequency domain positions in the system bandwidth and the part of transmit antenna ports are determined based on minimized channel noise and the third matrix; the column vector of the second matrix includes the frequency domain position and the transmit antenna port of the reference signal, and the frequency domain position and the transmit antenna port of the reference signal are determined based on the channel noise constraint condition and the first matrix; and the third matrix is a two-dimensional matrix that includes all the transmit antenna ports, all the receive antenna ports, and all the frequency domain positions, and a column vector of the third matrix includes a combination of the transmit antenna port, all the receive antenna ports, and all the frequency domain positions.

In the method, the first apparatus indicates the index of the column vector of the second matrix in the first matrix or the third matrix to the second apparatus, so that the frequency domain position and the transmit antenna port of the reference signal can be indicated, to help reduce indication overheads of the reference signal.

In the implementation in which the first apparatus sends the first indication information, the first apparatus sends a rule of a reference signal pattern to the second apparatus.

In the method, the first apparatus may directly indicate the rule of the reference signal pattern to the second apparatus, so that the second apparatus can determine the frequency domain position and the transmit antenna port of the reference signal according to the rule of the reference signal pattern, to help reduce indication overheads of the reference signal.

In the implementation in which the first apparatus sends the rule of the reference signal pattern to the second apparatus, the rule of the reference signal pattern includes one or more of the following: a 1^{st} position of the reference signal pattern on a frequency domain subcarrier and a transmit antenna port, a spacing between frequency domain subcarriers in the reference signal pattern, an interval between transmit antenna ports in the reference signal pattern, a quantity of frequency domain subcarriers in the reference signal pattern, and a quantity of transmit antenna ports in the reference signal pattern.

In the implementation in which the first apparatus sends the rule of the reference signal pattern to the second apparatus, the rule of the reference signal pattern includes a 1^{st} position of the reference signal pattern on a frequency domain subcarrier and a transmit antenna port, and/or an index of another reference signal position in the reference signal pattern.

In the foregoing method, the first apparatus needs to indicate, to the second apparatus, only a sequence number of the reference signal pattern or a rule for forming the reference signal pattern that is used for sending the reference signal, to help reduce indication overheads of the reference signal.

In a possible implementation, the first indication information includes a position of a frequency domain subcarrier and/or an index of the transmit antenna port.

In the implementation in which the first apparatus sends the first indication information, the first apparatus sends, to the second apparatus, a combination that is of a frequency domain position and a transmit antenna port position and that corresponds to an index of a column vector of a second matrix in a first matrix or a third matrix; or sends all frequency domain positions and all transmit antenna ports that correspond to an index of a column vector of a second matrix in a first matrix or a third matrix.

In the foregoing method, if the reference signal pattern is irregular in shape, the first apparatus may indicate, to the second apparatus, that only irregular reference signals are sent. Indication overheads are increased, but a quantity of resources used for sending the reference signal is reduced. Alternatively, the first apparatus may indicate, to the second apparatus, that all (regular) reference signals are sent. This helps reduce indication overheads but increases a quantity of resources used for sending the reference signal.

In a possible implementation, the first apparatus sends second indication information, where the second indication information indicates a frequency domain position or an index not for sending the reference signal, and/or an index of a transmit antenna port not for sending the reference signal.

In the method, if the reference signal pattern is irregular in shape, the first apparatus may indicate a regular reference signal pattern to the second apparatus, and indicate a few positions or indexes not for sending the reference signal, to help reduce indication overheads of the reference signal.

In a possible implementation, the first apparatus sends the reference signal at the frequency domain position through the transmit antenna port; or the first apparatus receives, at the frequency domain position, the reference signal sent through the transmit antenna port.

In the method, the first apparatus may be a network device, or may be a terminal device. Because the first apparatus learns of the frequency domain position for sending the reference signal, the first apparatus may receive or send the reference signal at the corresponding position, to help reduce overheads of an air interface.

In a possible implementation, the first apparatus may select, from the third matrix, a first initial column vector that satisfies a maximized trace of an antenna port-frequency domain orthogonal basis matrix. The first apparatus sequentially selects, from the third matrix, column vectors that satisfy the channel noise constraint condition, and combines a column vector selected each time with the first initial column vector to obtain a fourth matrix, where a column vector dimension of the fourth matrix satisfies a preset maximum expected carrier quantity and transmit antenna port quantity. The first apparatus determines a frequency domain position and a transmit antenna port position that correspond to an index of each column vector of the fourth matrix in the third matrix; and combines the frequency domain position, the transmit antenna port, and all the receive antenna ports to obtain the first matrix. The first apparatus sequentially selects, from the first matrix, column vectors of the minimized channel noise, and combines a column vector selected each time with the fourth matrix to obtain the second matrix, where a column vector dimension of the second matrix satisfies a rank of the third matrix and satisfies the channel noise constraint condition.

In a possible implementation, the first apparatus determines a plurality of column vectors that correspond to a transmit antenna port and a frequency domain position that satisfy a preset reference signal pattern limitation condition, and all the receive antenna ports, to form the first matrix, where the preset reference signal pattern limitation condition includes one or more of the following: an interval between transmit antenna ports, a spacing between frequency domain subcarriers, a maximum quantity of transmit antenna ports, and a maximum quantity of frequency domain subcarriers. The first apparatus selects, from the first matrix, a second initial column vector that satisfies a maximized trace of an antenna port-frequency domain orthogonal basis matrix; and sequentially selects, from the first matrix, column vectors that satisfy the channel noise constraint condition, and combines a column vector selected each time with the second initial column vector to obtain the second matrix, where a column vector dimension of the second matrix satisfies a rank of the third matrix and satisfies the channel noise constraint condition.

In the foregoing method, the first apparatus may further perform matrix simplification and derivation based on a channel matrix, to determine the frequency domain position and the transmit antenna port of the reference signal, so as to help reduce overheads of a sounding reference signal for channel estimation, reduce a measurement delay, and improve accuracy of the channel estimation.

According to a second aspect, this application provides a communication method. The method is performed by a second apparatus. The second apparatus may be a terminal device, or may be a component (for example, a processor, a chip, or a chip system) of the terminal device, or may be a logical module that can implement all or a part of functions of the terminal device. The second apparatus receives first indication information, where the first indication information indicates a frequency domain position and a transmit antenna port of a reference signal. The second apparatus determines the frequency domain position and the transmit antenna port of the reference signal based on the first indication information, where the frequency domain position and the transmit antenna port of the reference signal are associated with a channel noise constraint condition.

In the method, the second apparatus may determine the frequency domain position and the transmit antenna port of the reference signal based on the first indication information, to help reduce overheads of a sounding reference signal for channel estimation, reduce a measurement delay, and improve accuracy of the channel estimation.

In a possible implementation, the channel noise constraint condition includes a minimized channel noise-based reference signal selection criterion. Optionally, the channel noise constraint condition further includes a termination threshold that satisfies a minimum signal-to-noise ratio.

In a possible implementation, the channel noise constraint condition is associated with at least one or more of the following parameters: a quantity of receive antennas, a quantity of frequency domain subcarriers, power of a transmit end, noise power of a channel, and a lower limit of a received signal-to-noise ratio.

In a possible implementation, frequency domain positions of the reference signal are partially continuous in a system bandwidth or a BWP allocated to a terminal device, and transmit antenna ports of the reference signal are partially continuous in a set including all transmit antenna ports.

In the method, a position of the reference signal follows specific regularity, to help reduce indication overheads of the reference signal.

In a possible implementation, all frequency domain positions of the reference signal correspond to a same transmit antenna port.

In a possible implementation, some frequency domain positions of the reference signal correspond to a same transmit antenna port.

In the foregoing method, the antenna port and the frequency domain position follow specific regularity, to help reduce indication overheads of the reference signal.

In the implementation in which the second apparatus receives the first indication information, the second apparatus receives an index of a column vector of a second matrix in a first matrix or a third matrix. The first matrix includes a part of frequency domain positions in the system bandwidth, a part of transmit antenna ports, and all receive antenna ports, and the part of frequency domain positions in the system bandwidth and the part of transmit antenna ports are determined based on minimized channel noise and the third matrix; the column vector of the second matrix includes the frequency domain position and the transmit antenna port of the reference signal, and the frequency domain position and the transmit antenna port of the reference signal are determined based on the channel noise constraint condition and the first matrix; and the third matrix is a two-dimensional matrix that includes all the transmit antenna ports, all the receive antenna ports, and all the frequency domain positions, and a column vector of the third matrix includes a combination of the transmit antenna port, all the receive antenna ports, and all the frequency domain positions.

In the method, the second apparatus may determine the frequency domain position and the transmit antenna port of the reference signal based on the index that is of the column vector of the second matrix in the first matrix or the third matrix and that is indicated by a first apparatus, to help reduce overheads of a sounding reference signal for channel estimation, reduce a measurement delay, and improve accuracy of the channel estimation.

In the implementation in which the second apparatus receives the first indication information, the second apparatus receives a rule of a reference signal pattern.

In the implementation in which the second apparatus receives the rule of the reference signal pattern, the rule of the reference signal pattern includes one or more of the following: a 1^{st} position of the reference signal pattern on a frequency domain subcarrier and a transmit antenna port, a spacing between frequency domain subcarriers in the reference signal pattern, an interval between transmit antenna ports in the reference signal pattern, a quantity of frequency domain subcarriers in the reference signal pattern, and a quantity of transmit antenna ports in the reference signal pattern.

In the implementation in which the second apparatus receives the rule of the reference signal pattern, the rule of the reference signal pattern includes a 1^{st} position of the reference signal pattern on a frequency domain subcarrier and a transmit antenna port, and/or an index of another reference signal position in the reference signal pattern.

In a possible implementation, the first indication information includes a position of a frequency domain subcarrier and/or an index of the transmit antenna port.

In the implementation in which the second apparatus receives the first indication information, the second apparatus receives a combination that is of a frequency domain position and a transmit antenna port and that corresponds to an index of a column vector of a second matrix in a first matrix or a third matrix; or receives all frequency domain positions and all transmit antenna ports that correspond to an index of a column vector of a second matrix in a first matrix or a third matrix.

In the foregoing method, if the reference signal pattern is irregular in shape, the first apparatus may indicate, to the second apparatus, that only irregular reference signals are sent. Indication overheads are increased, but a quantity of resources used for sending the reference signal is reduced. Alternatively, the first apparatus may indicate, to the second apparatus, that all (regular) reference signals are sent. This helps reduce indication overheads but increases a quantity of resources used for sending the reference signal.

In a possible implementation, the second apparatus receives second indication information, where the second indication information indicates a frequency domain position or an index not for sending the reference signal, and/or an index of a transmit antenna port not for sending the reference signal.

In the method, if the reference signal pattern is irregular in shape, the first apparatus may indicate a regular reference signal pattern to the second apparatus, and indicate a few positions or indexes not for sending the reference signal, so that the second apparatus may send the reference signal only at a part of positions and antenna ports based on the indication, to help reduce resources used for sending the reference signal.

In a possible implementation, the second apparatus receives, at the frequency domain position, the reference signal sent through the transmit antenna port; or sends the reference signal at the frequency domain position through the transmit antenna port.

In the method, the second apparatus may be a terminal device, or may be a network device. Because the second apparatus learns of the frequency domain position for sending the reference signal, the second apparatus may receive or send the reference signal at the corresponding position, to help reduce overheads of an air interface.

According to a third aspect, this application provides a communication apparatus. The communication apparatus may be a network device, an apparatus in the network device, or an apparatus that can be used in a matching manner with the network device. In a possible implementation, the communication apparatus may include a functional module. The functional module may be implemented by a hardware circuit, software, or a combination of a hardware circuit and software.

In a possible implementation, the communication apparatus includes a communication unit and a processing unit. The processing unit is configured to determine a frequency domain position and a transmit antenna port of a reference signal based on a channel noise constraint condition. The communication unit is configured to send first indication information, where the first indication information indicates the frequency domain position and the transmit antenna port of the reference signal.

In a possible implementation, the channel noise constraint condition includes a minimized channel noise-based reference signal selection criterion. Optionally, the channel noise constraint condition further includes a termination threshold that satisfies a minimum signal-to-noise ratio.

In a possible implementation, the channel noise constraint condition is associated with at least one or more of the following parameters: a quantity of receive antennas, a quantity of frequency domain subcarriers, power of a transmit end, noise power of a channel, and a lower limit of a received signal-to-noise ratio.

In a possible implementation, that the processing unit is configured to determine the frequency domain position and the transmit antenna port of the reference signal based on the channel noise constraint condition includes determining the frequency domain position and the transmit antenna port of the reference signal based on one or more of parameters such as a quantity of receive antennas, a quantity of frequency domain subcarriers, power of a transmit end, noise power of a channel, and a lower limit of a received signal-to-noise ratio.

In a possible implementation, frequency domain positions of the reference signal are partially continuous in a system bandwidth or a BWP allocated to a terminal device, and transmit antenna ports of the reference signal are partially continuous in a set including all transmit antenna ports.

In a possible implementation, all frequency domain positions of the reference signal correspond to a same transmit antenna port.

In a possible implementation, some frequency domain positions of the reference signal correspond to a same transmit antenna port.

In a possible implementation, that the communication unit is configured to send the first indication information includes sending an index of a column vector of a second matrix in a first matrix or a third matrix to a second apparatus. The first matrix includes a part of frequency domain positions in the system bandwidth, a part of transmit antenna ports, and all receive antenna ports, and the part of frequency domain positions in the system bandwidth and the part of transmit antenna ports are determined based on minimized channel noise and the third matrix; the column vector of the second matrix includes the frequency domain position and the transmit antenna port of the reference signal, and the frequency domain position and the transmit antenna port of the reference signal are determined based on the channel noise constraint condition and the first matrix; and the third matrix is a two-dimensional matrix that includes all the transmit antenna ports, all the receive antenna ports, and all the frequency domain positions, and a column vector of the third matrix includes a combination of the transmit antenna port, all the receive antenna ports, and all the frequency domain positions.

In a possible implementation, that the communication unit is configured to send the first indication information includes sending a rule of a reference signal pattern to the second apparatus.

In a possible implementation, the rule of the reference signal pattern includes one or more of the following: a 1^{st} position of the reference signal pattern on a frequency domain subcarrier and a transmit antenna port, a spacing between frequency domain subcarriers in the reference signal pattern, an interval between transmit antenna ports in the reference signal pattern, a quantity of frequency domain subcarriers in the reference signal pattern, and a quantity of transmit antenna ports in the reference signal pattern.

In a possible implementation, the rule of the reference signal pattern includes a 181 position of the reference signal pattern on a frequency domain subcarrier and a transmit antenna port, and/or an index of another reference signal position in the reference signal pattern.

In a possible implementation, the first indication information includes a position of a frequency domain subcarrier and/or an index of the transmit antenna port.

In a possible implementation, that the communication unit is configured to send the first indication information includes sending a combination that is of a frequency domain position and a transmit antenna port position and that corresponds to an index of a column vector of a second matrix in a first matrix or a third matrix; or sending all frequency domain positions and all transmit antenna ports that correspond to an index of a column vector of a second matrix in a first matrix or a third matrix.

In a possible implementation, the communication unit is further configured to send second indication information, where the second indication information indicates a frequency domain position or an index not for sending the reference signal, and/or an index of a transmit antenna port not for sending the reference signal.

In a possible implementation, the communication unit is further configured to send the reference signal at the frequency domain position through the transmit antenna port; or receive, at the frequency domain position, the reference signal sent through the transmit antenna port.

In a possible implementation, the processing unit is further configured to select, from the third matrix, a first initial column vector that satisfies a maximized trace of an antenna port-frequency domain orthogonal basis matrix; sequentially select, from the third matrix, column vectors that satisfy the channel noise constraint condition, and combine a column vector selected each time with the first initial column vector to obtain a fourth matrix, where a column vector dimension of the fourth matrix satisfies a preset maximum expected carrier quantity and transmit antenna port quantity; determine a frequency domain position and a transmit antenna port position that correspond to an index of each column vector of the fourth matrix in the third matrix; combine the frequency domain position, the transmit antenna port, and all the receive antenna ports to obtain the first matrix; and sequentially select, from the first matrix, column vectors of the minimized channel noise, and combine a column vector selected each time with the fourth matrix to obtain the second matrix, where a column vector dimension of the second matrix satisfies a rank of the third matrix and satisfies the channel noise constraint condition.

In a possible implementation, the processing unit is further configured to determine a plurality of column vectors that correspond to a transmit antenna port and a frequency domain position that satisfy a preset reference signal pattern limitation condition, and all the receive antenna ports, to form the first matrix, where the preset reference signal pattern limitation condition includes one or more of the following: an interval between transmit antenna ports, a spacing between frequency domain subcarriers, a maximum quantity of transmit antenna ports, and a maximum quantity of frequency domain subcarriers; select, from the first matrix, a second initial column vector that satisfies a maximized trace of an antenna port-frequency domain orthogonal basis matrix; and sequentially select, from the first matrix, column vectors that satisfy the channel noise constraint condition, and combine a column vector selected each time with the second initial column vector to obtain the second matrix, where a column vector dimension of the second matrix satisfies a rank of the third matrix and satisfies the channel noise constraint condition.

According to a fourth aspect, this application provides a communication apparatus. The communication apparatus may be a network device, an apparatus in the network device, or an apparatus that can be used in a matching manner with the network device. In a possible implementation, the communication apparatus may include a functional module. The functional module may be implemented by a hardware circuit, software, or a combination of a hardware circuit and software.

In a possible implementation, the communication apparatus includes a communication unit and a processing unit. The communication unit is configured to receive first indication information, where the first indication information indicates a frequency domain position and a transmit antenna port of a reference signal. The processing unit is configured to determine the frequency domain position and the transmit antenna port of the reference signal based on the first indication information, where the frequency domain position and the transmit antenna port of the reference signal are associated with a channel noise constraint condition.

In a possible implementation, the channel noise constraint condition includes a minimized channel noise-based reference signal selection criterion. Optionally, the channel noise constraint condition further includes a termination threshold that satisfies a minimum signal-to-noise ratio.

In a possible implementation, the channel noise constraint condition is associated with at least one or more of the following parameters: a quantity of receive antennas, a quantity of frequency domain subcarriers, power of a transmit end, noise power of a channel, and a lower limit of a received signal-to-noise ratio.

In a possible implementation, frequency domain positions of the reference signal are partially continuous in a system bandwidth or a BWP allocated to a terminal device, and transmit antenna ports of the reference signal are partially continuous in a set including all transmit antenna ports.

In a possible implementation, all frequency domain positions of the reference signal correspond to a same transmit antenna port.

In a possible implementation, some frequency domain positions of the reference signal correspond to a same transmit antenna port.

In a possible implementation, that the communication unit is configured to receive the first indication information includes: receiving an index of a column vector of a second matrix in a first matrix or a third matrix. The first matrix includes a part of frequency domain positions in the system bandwidth, a part of transmit antenna ports, and all receive antenna ports, and the part of frequency domain positions in the system bandwidth and the part of transmit antenna ports are determined based on minimized channel noise and the third matrix; the column vector of the second matrix includes the frequency domain position and the transmit antenna port of the reference signal, and the frequency domain position and the transmit antenna port of the reference signal are determined based on the channel noise constraint condition and the first matrix; and the third matrix is a two-dimensional matrix that includes all the transmit antenna ports, all the receive antenna ports, and all the frequency domain positions, and a column vector of the third matrix includes a combination of the transmit antenna port, all the receive antenna ports, and all the frequency domain positions.

In a possible implementation, that the communication unit is configured to receive the first indication information includes: receiving a rule of a reference signal pattern.

In a possible implementation, the rule of the reference signal pattern includes one or more of the following: a 1^{st} position of the reference signal pattern on a frequency domain subcarrier and a transmit antenna port, a spacing between frequency domain subcarriers in the reference signal pattern, an interval between transmit antenna ports in the reference signal pattern, a quantity of frequency domain subcarriers in the reference signal pattern, and a quantity of transmit antenna ports in the reference signal pattern.

In a possible implementation, the rule of the reference signal pattern includes a 1^{st} position of the reference signal pattern on a frequency domain subcarrier and a transmit antenna port, and/or an index of another reference signal position in the reference signal pattern.

In a possible implementation, the first indication information includes a position of a frequency domain subcarrier and/or an index of the transmit antenna port.

In a possible implementation, that the communication unit is configured to receive the first indication information includes: receiving a combination that is of a frequency domain position and a transmit antenna port and that corresponds to an index of a column vector of a second matrix in a first matrix or a third matrix; or receiving all frequency domain positions and all transmit antenna ports that correspond to an index of a column vector of a second matrix in a first matrix or a third matrix.

In a possible implementation, the communication unit is further configured to receive second indication information, where the second indication information indicates a frequency domain position or an index not for sending the reference signal, and/or an index of a transmit antenna port not for sending the reference signal.

In a possible implementation, the communication unit is further configured to receive, at the frequency domain position, the reference signal sent through the transmit antenna port; or send the reference signal at the frequency domain position through the transmit antenna port.

For the third aspect or the fourth aspect, in an example, the processing unit may be a processor, and the communication unit may be a transceiver unit, a transceiver, or a communication interface. It may be understood that when the communication apparatus is a communications device (for example, a terminal device or a network device), the communication unit may be a transceiver in the communication apparatus, for example, implemented by using an antenna, a feeder, a codec, or the like in the communication apparatus. Alternatively, if the communication apparatus is a chip disposed in a device, the processing unit may be a processing circuit, a logic circuit, or the like of the chip, and the communication unit may be an input/output interface of the chip, for example, an input/output circuit or a pin.

According to a fifth aspect, this application provides a communication apparatus, including a processor, configured to execute instructions. Optionally, the communication apparatus further includes a memory. The memory is configured to store the instructions. When the instructions are executed by the processor, the communication apparatus is enabled to implement the method according to any one of the first aspect or the possible implementations of the first aspect. Optionally, the processor is coupled to the memory.

According to a sixth aspect, this application provides a communication apparatus, including a processor, configured to execute instructions. Optionally, the communication apparatus further includes a memory. The memory is configured to store the instructions. When the instructions are executed by the processor, the communication apparatus is enabled to implement the method according to any one of the second aspect or the possible implementations of the second aspect. Optionally, the processor is coupled to the memory.

According to a seventh aspect, this application provides a communication system. The communication system includes a plurality of the apparatus or devices according to the third to sixth aspects. The apparatuses or devices are enabled to perform the methods according to the first aspect and the second aspect and any one of the possible implementations of the first aspect and the second aspect.

According to an eighth aspect, this application provides a computer-readable storage medium. The computer-readable storage medium stores instructions. When the instructions are run on a computer, the computer is enabled to perform the methods according to the first aspect and the second aspect and any one of the possible implementations of the first aspect and the second aspect.

According to a ninth aspect, this application provides a chip system. The chip system includes a processor and an interface, optionally, may further include a memory, and is configured to implement the methods according to the first aspect and the second aspect and any one of the possible implementations of the first aspect and the second aspect. The chip system may include a chip, or may include a chip and another discrete component.

According to a tenth aspect, this application provides a computer program product, including instructions. When the instructions are run on a computer, the computer is enabled to perform the methods according to the first aspect and the second aspect and any one of the possible implementations of the first aspect and the second aspect.

### BRIEF DESCRIPTION OF DRAWINGS

FIG. 1 is a diagram of a communication system according to this application;

FIG. 2 is a diagram of a design solution for a sounding reference signal of channel subspace;

FIG. 3 is a diagram of a sounding reference signal pattern;

FIG. 4 is a schematic flowchart of a communication method according to this application;

FIG. 5 is a diagram of a reference signal pattern;

FIG. 6 is a diagram of a candidate reference signal pattern;

FIG. 7 is a schematic flowchart in which a first apparatus determines a reference signal pattern based on a channel matrix and a channel noise constraint condition according to this application;

FIG. 8 is a diagram in which a first apparatus obtains a second matrix according to this application;

FIG. 9 is a schematic flowchart in which a first apparatus determines a reference signal pattern based on a preset reference signal pattern limitation condition and a channel noise constraint condition according to this application;

FIG. 10A is a diagram of a rule of a reference signal pattern according to this application;

FIG. 10B is a diagram of a rule of another reference signal pattern according to this application;

FIG. 11A is a diagram of a combination of a frequency domain position and a transmit antenna port position according to this application;

FIG. 11B is a diagram of another combination of a frequency domain position and a transmit antenna port position according to this application;

FIG. 12 is a diagram of separately indicating a position of a frequency domain subcarrier and an index of a transmit antenna port according to this application;

FIG. 13 is a diagram of first indication information and second indication information according to this application;

FIG. 14 is a schematic flowchart in which a second apparatus determines a reference signal pattern and sends the reference signal pattern and a reference signal to a first apparatus according to this application;

FIG. 15 is a diagram of simulation of a reference signal pattern carried by 16 resource blocks according to this application;

FIG. 16 is a diagram of simulation of downlink spectral efficiency of a reference signal carried by 16 resource blocks according to this application;

FIG. 17 is a diagram of simulation of a reference signal pattern carried by 32 resource blocks according to this application;

FIG. 18 is a diagram of simulation of downlink spectral efficiency of a reference signal carried by 32 resource blocks according to this application;

FIG. 19 is a diagram of simulation of a fixed reference signal pattern according to this application;

FIG. 20 is a diagram of a communication apparatus according to this application; and

FIG. 21 is a diagram of another communication apparatus according to this application.

### DESCRIPTION OF EMBODIMENTS

In embodiments of this application, “/” may represent an “or” relationship between associated objects. For example, A/B may represent A or B. “and/or” may be used to describe that there are three relationships between associated objects. For example, A and/or B may represent the following three cases: Only A exists, both A and B exist, and only B exists, where A and B may be singular or plural. For ease of describing the technical solutions in embodiments of this application, in embodiments of this application, the terms such as “first” and “second” may be used to distinguish technical features with a same or similar function. The terms such as “first” and “second” are not intended to limit a quantity and an execution sequence, and the terms such as “first” and “second” are not intended to limit a definite difference. In embodiments of this application, the term like “example” or “for example” is used to represent an example, evidence, or a description. Any embodiment or design solution described as “example” or “for example” should not be explained as being more preferred or having more advantages than another embodiment or design solution. The term like “example” or “for example” is used to present a related concept in a specific manner for ease of understanding.

The following describes the technical solutions in embodiments of this application with reference to the accompanying drawings in embodiments of this application.

To reduce overheads of a reference signal for channel estimation, this application provides a communication method. The communication method can greatly reduce the overheads of the reference signal for the channel estimation in a case of a large-scale antenna.

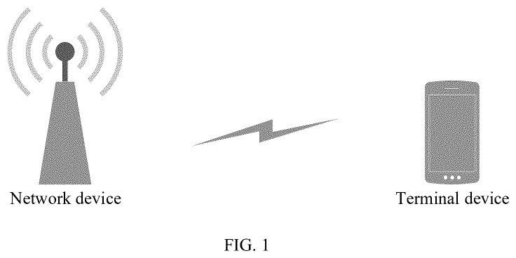

The communication method provided in this application may be applied to a communication system shown in FIG. 1. For example, the communication system includes a network device and a terminal device.

The communication system in this application may include but is not limited to communication systems of various radio access technologies (RATs), for example, may be a narrow band-Internet of things (NB-IoT) system, a Long-Term Evolution (LTE) communication system, a 5^{th} generation (5G) (or referred to as new radio (NR)) communication system, or a transition system between an LTE communication system and a 5G communication system. The transition system may also be referred to as a 4.5G communication system, or certainly may be a future communication system, for example, a 6^{th} generation (6G) system or even a 7^{th} generation (7G) system. A network architecture and a service scenario described in embodiments of this application are intended to describe the technical solutions in embodiments of this application more clearly, and do not constitute a limitation on the technical solutions provided in embodiments of this application. A person of ordinary skill in the art may know that with evolution of communication network architectures and emergence of new service scenarios, the technical solutions provided in embodiments of this application are also applicable to similar technical problems.

The terminal device, also referred to as user equipment (UE), a mobile station (MS), a mobile terminal (MT), or the like, is a device that provides voice and/or data connectivity for a user, for example, a handheld device or a vehicle-mounted device having a wireless connection function. Currently, some examples of the terminal device are: a mobile phone, a tablet computer, a notebook computer, a palmtop computer, a mobile internet device (MID), a wearable device, an uncrewed aerial vehicle, a virtual reality (VR) device, an augmented reality (AR) device, a wireless terminal in industrial control, a wireless terminal in self driving, a wireless terminal in remote medical surgery, a wireless terminal in a smart grid, a wireless terminal in transportation safety, a wireless terminal in a smart city, a wireless terminal in a smart home, a terminal device in a 5G network, a terminal device in a future evolved public land mobile network (PLMN) network, a terminal device in a future communication system, or the like.

The network device in this application is a radio access network (RAN) node (or device) that connects the terminal device to a wireless network, and may also be referred to as a base station. For example, examples of some RAN nodes are: a continuously evolved next-generation NodeB (gNB), a transmission and reception point (TRP), an evolved NodeB (eNB), a radio network controller (RNC), a NodeB (NB), a base station controller (BSC), a base transceiver station (BTS), a home base station (for example, a home eNB, or a home NodeB (HNB)), a baseband unit (BBU), a Wi-Fi access point (AP), a satellite in a satellite communication system, a radio controller in a cloud radio access network (CRAN) scenario, a wearable device, an uncrewed aerial vehicle, a device in an IoT (for example, a vehicle-to-everything (V2X) device), a communication device in device-to-device (D2D) communication, or the like. In addition, in a network structure, the network device may include a central unit (CU) node, a distributed unit (DU) node, or a RAN device including a CU node and a DU node. The RAN device including the CU node and the DU node splits protocol layers of an eNB in an LTE system. Functions of a part of protocol layers are centrally controlled by a CU, functions of a part of or all of remaining protocol layers are distributed in a DU, and the CU centrally controls the DU. In some deployment of the network device, the CU may be further split into a CU-control plane (CP), a CU-user plane (UP), and the like. In some other deployment of the network device, the network device may alternatively be an antenna unit (RU), or the like. In still some other deployment of the network device, the network device may alternatively be an open radio access network (ORAN) architecture or the like. A specific type of the network device is not limited in this application. For example, when the network device is of the ORAN architecture, the network device in embodiments of this application may be an access network device in an ORAN, a module in the access network device, or the like. In an ORAN system, a CU may also be referred to as an open (O)-CU, a DU may also be referred to as an O-DU, a CU-DU may also be referred to as an O-CU-DU, a CU-UP may also be referred to as an O-CU-UP, and an RU may also be referred to as an O-RU.

It should be noted that: “sending” and “receiving” in embodiments of this application represent signal transfer directions. For example, “sending configuration information to a terminal device” may be understood as that a destination end of the configuration information is the terminal device, and may include direct sending through an air interface, or indirect sending by another unit or module through an air interface. “Receiving configuration information from the network device” may be understood as that a source end of the configuration information is the network device, and may include direct receiving from the network device through an air interface, or indirect receiving from the network device from another unit or module through the air interface. “Sending” may alternatively be understood as “outputting” of a chip interface, and “receiving” may alternatively be understood as “inputting” of the chip interface.

In other words, sending and receiving may be performed between devices, for example, between the network device and the terminal device, or may be performed in a device, for example, sending or receiving is performed between components, modules, chips, software modules, or hardware modules in a device through a bus, a cable, or an interface.

It may be understood that necessary processing, for example, encoding and modulation, may be performed on information between a source end and a destination end of information sending, but the destination end may understand effective information from the source end. Similar descriptions in this application may be understood similarly. Details are not described again.

In embodiments of this application, “indication” may include a direct indication and an indirect indication, or may include an explicit indication and an implicit indication. Information indicated by a piece of information (for example, the following indication information) is referred to as to-be-indicated information. In a specific implementation process, the to-be-indicated information may be indicated in a plurality of manners, for example, but not limited to, directly indicating the to-be-indicated information, for example, indicating the to-be-indicated information, an index of the to-be-indicated information, or the like. Alternatively, the to-be-indicated information may be indirectly indicated by indicating other information. There is an association relationship between the other information and the to-be-indicated information. Alternatively, only a part of the to-be-indicated information may be indicated, and the remaining part of the to-be-indicated information is known or pre-agreed on. For example, specific information may alternatively be indicated by using an arrangement sequence of pieces of information that are pre-agreed on (for example, predefined in a protocol), to reduce indication overheads to some extent. A specific indication manner is not limited in this application. It may be understood that, for a sender of the indication information, the indication information may indicate to-be-indicated information, and for a receiver of the indication information, the indication information may be for determining to-be-indicated information.

### I. For Ease of Understanding, the Following Describes in Detail Definitions of Related Terms in this Application

### 1. Multiple-Input Multiple-Output (MIMO) Channel Estimation

Due to frequency selective fading, a Doppler shift, and the like, a reference signal needs to be used for channel estimation. For example, in a 6G application scenario, a size of an antenna of a device is greatly increased. As a quantity of physical ports is greatly increased, overheads of the reference signal for the channel estimation are also greatly increased. For example, at least 32 antenna ports and 16 frequency domain resource blocks (RBs) may be included for a scale of an uplink reference signal for a single user of future 6G MIMO, and a large quantity of air interface resources and frequency domain resources are occupied.

### 2. Design for a Sounding Reference Signal of Channel Subspace

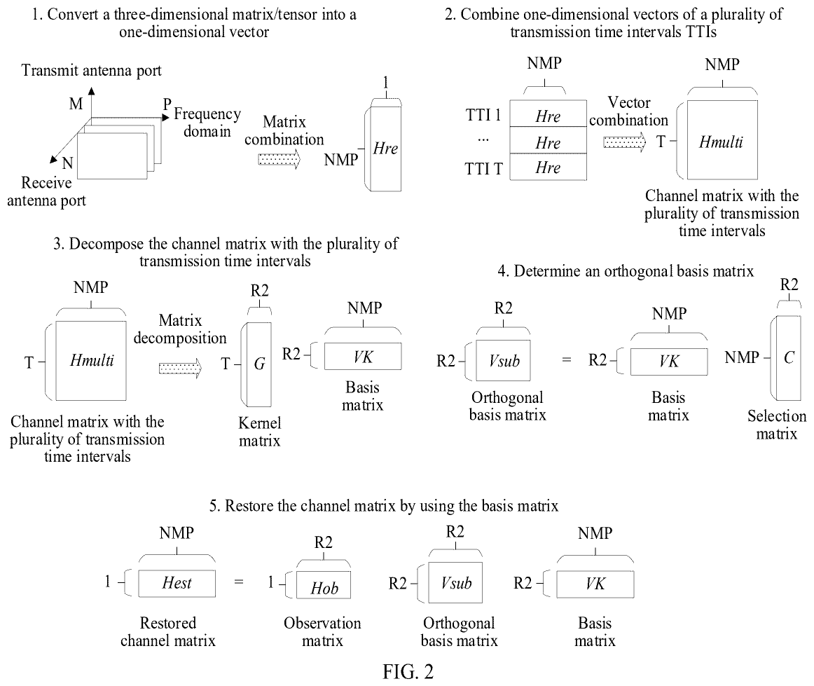

For example, FIG. 2 is a diagram of a design solution for a sounding reference signal of channel subspace. A main idea of the solution is to convert a channel matrix into a vector and concatenate vectors into a matrix through a plurality of transmission time intervals (TTIs). Singular value decomposition (SVD) and QR decomposition are used to find a sparse SRS. The design solution for the sounding reference signal of the channel subspace shown in FIG. 2 may include the following steps.

Step 1: Convert a three-dimensional matrix/tensor of a transmit antenna port, a receive antenna port, and a frequency domain subcarrier into a one-dimensional vector Hᵣₑ. A length of the one-dimensional vector Hᵣₑ is NMP. N is a quantity of receive antenna ports, M is a quantity of transmit antenna ports, and P is a quantity of frequency domain subcarriers. For uplink transmission, the transmit antenna port is an antenna port (UE port) of a terminal device, and the receive antenna port is an antenna port (BS port) of a network device. On the contrary, for downlink transmission, the transmit antenna port is an antenna port (BS port) of a network device, and the receive antenna port is an antenna port (UE port) of a terminal device. In this application, the uplink transmission is used as an example for description. The network device may convert the three-dimensional matrix into the one-dimensional vector, or the terminal device may convert the three-dimensional matrix into the one-dimensional vector.

Step 2: Concatenate respective one-dimensional vectors Hᵣₑ of a plurality of transmission time intervals into a channel matrix Hₘᵤₗₜᵢ with the plurality of TTIs by using channel information of the plurality of TTIs. The channel matrix Hₘᵤₗₜᵢ is a T*NMP matrix, and T is a quantity of TTIs.

Step 3: Decompose the channel matrix with the plurality of transmission time intervals in step 2 (in other words, perform SVD decomposition on the channel matrix Hₘᵤₗₜᵢ) to obtain a kernel matrix (and a basis matrix VK. The kernel matrix (is a T*R2 matrix, and R2 is a rank of the basis matrix. The basis matrix VK is an R2*NMP matrix.

Step 4: Determine an orthogonal basis matrix V_{sub} through QR decomposition, where a sequence corresponding to each row of the orthogonal basis matrix is a position of an SRS resource in frequency domain and on an antenna port. The orthogonal basis matrix V_{sub} is an R2*R2 matrix.

Step 5: For the uplink transmission, the terminal device sends the reference signal at the position of the SRS resource obtained through decomposition, and the network device restores an entire channel matrix Hₑₛₜ by using the basis matrix.

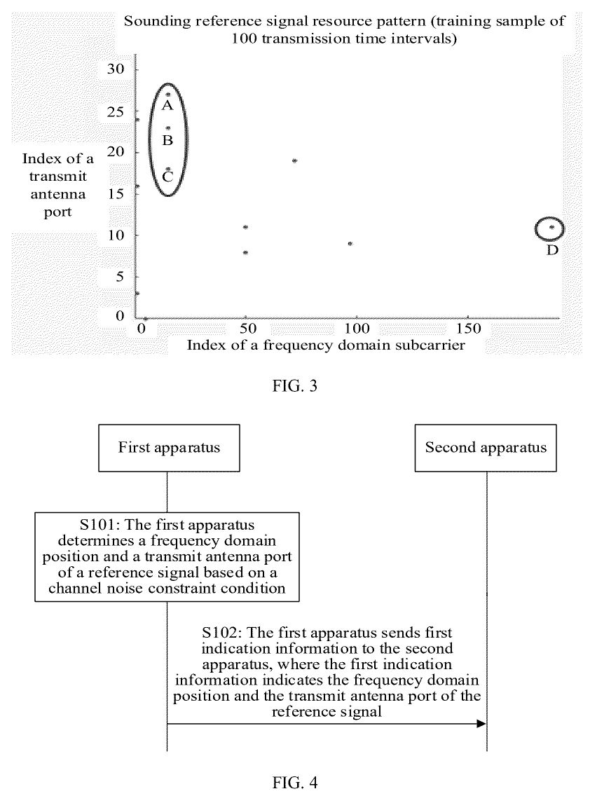

An SRS reference signal pattern generated based on the foregoing design solution is shown in FIG. 3. Positions of the reference signal in the SRS reference signal pattern are sparse. For example, a plurality of points in FIG. 3 respectively represent a plurality of positions of the reference signal. Indexes of frequency domain subcarriers corresponding to three positions that are of the reference signal and that are represented by three points A, B, and C may be considered to be the same, and only positions of antenna ports need to be indicated to indicate the positions of the reference signal. However, an index of a frequency domain subcarrier corresponding to a position that is of the reference signal and that is represented by a point D differs greatly from the indexes of the frequency domain subcarriers corresponding to the three positions that are of the reference signal and that are represented by the three points A, B, and C. Therefore, a frequency domain position and a position of an antenna port need to be separately indicated, resulting in a great increase in indication overheads. In addition, quantities of transmit antenna ports on frequency domain subcarriers are inconsistent, and consequently, a peak-to-average power ratio (PAPR) may be excessively high.

### 3. Channel Restoration in a Noisy Channel Condition

For example, in a noise-free channel condition, a reference signal pattern determined by decomposing a channel matrix is similar to a reference signal pattern (for example, any selected reference signal pattern) determined without decomposition. In other words, in the noise-free channel condition, a reference signal pattern of a reference signal may be arbitrary. Therefore, channel noise is a key factor that affects the reference signal pattern. For example, Formula (1) is a formula of channel restoration in the noisy channel condition:

$${H}_{est} = {H}_{ob} * {{V}_{sub}}^{- 1} * VK = ( {GV}_{sub} + S ) * {{V}_{sub}}^{- 1} * VK = {GV}_{sub} {{V}_{sub}}^{- 1} * VK + {{SV}_{sub}}^{- 1} * VK = H + {{SV}_{sub}}^{- 1} * VK \qquad ( 1 )$$

A noise term may be derived as

$${NVK}_{sub}^{- 1} * VK$$

by performing processing on Formula (1). Hₑₛₜ represents a channel estimation matrix. H_{ob} represents an observation matrix (where the observation matrix is a channel matrix that can be directly measured by a receive end after a transmit end sends a reference signal, and the observation matrix includes positions in frequency domain and on transmit antenna ports and receive antenna ports that are in the channel matrix and that correspond to each row of an orthogonal basis matrix V_{sub}). V_{sub} represents the orthogonal basis matrix (where columns are linearly independent, and a discrete matrix may be represented by using the orthogonal basis matrix). VK represents a basis matrix (which carries large-scale information of a channel, such as an angle of arrival, an angle of a transmit angle, and a delay). S represents a noise matrix. H represents a noise-free channel matrix. G represents a kernel matrix, and the kernel matrix is a channel coefficient matrix that changes with time.

It can be learned based on derivation in Formula (1) that, if the channel noise is minimized, a restored actual channel may be more accurate. For example, minimizing the channel noise may be equivalent to minimizing a trace of the channel matrix (where a trace of the noise matrix represents noise power). Therefore, Formula (2) represents a result derived from a minimized channel noise:

$$min E \{ trace ( {{SV}_{sub}}^{- 1} * VK ) \} \qquad ( 2 )$$

$$min E \{ trace ( {V}^{H} {{V}_{sub}}^{- H} {S}^{H} {{SV}_{sub}}^{- 1} VK ) \} = min trace ( {V}^{H} {{V}_{sub}}^{- H} E \{ {S}^{H} S \} {{V}_{sub}}^{- 1} VK ) = min {σ}^{2} trace ( {V}^{H} {{V}_{sub}}^{- H} {{V}_{sub}}^{- 1} VK ) = min {σ}^{2} trace ( {( {{V}_{sub}}^{- 1} V )}^{H} {{V}_{sub}}^{- 1} VK ) = min {σ}^{2} trace ( {{V}_{sub}}^{- 1} {{V}_{sub}}^{- H} )$$

E{ } represents taking a mean value, trace( ) represents the trace of the matrix, and σ² represents noise power of a channel (for example, a variance of noise). For example, if the channel noise satisfies white Gaussian noise distribution, the variance of the noise remains constant. Therefore, a minimized channel noise-based reference signal selection criterion satisfies Formula (3):

$$min {σ}^{2} trace ( {{V}_{sub}}^{- 1} {{V}_{sub}}^{- H} ) \qquad ( 3 )$$

### II. Communication Method Provided in this Application

FIG. 4 is a schematic flowchart of a communication method according to this application. The communication method is applied to the communication system shown in FIG. 1. For example, the communication method may be implemented through interaction between a first apparatus and a second apparatus. Optionally, when the first apparatus is a network device, the second apparatus may be a terminal device; or when the first apparatus is a terminal device, the second apparatus may be a network device. The communication method includes the following steps.

S101: The first apparatus determines a frequency domain position and a transmit antenna port of a reference signal based on a channel noise constraint condition.

The channel noise constraint condition includes a minimized channel noise-based reference signal selection criterion and a termination threshold that satisfies a minimum signal-to-noise ratio. For example, according to the foregoing descriptions of the minimized channel noise, the minimized channel noise-based reference signal selection criterion in this application may include power of the minimized channel noise, that is, a trace of a minimized channel matrix. The channel noise constraint condition is associated with at least one or more of the following parameters: a quantity of receive antennas, a quantity of frequency domain subcarriers, power of a transmit end, noise power of a channel, and a lower limit of a received signal-to-noise ratio. For example, that the first apparatus determines the frequency domain position and the transmit antenna port of the reference signal based on the channel noise constraint condition may be that the first apparatus determines the frequency domain position and the transmit antenna port of the reference signal based on one or more of parameters such as the quantity of receive antennas, the quantity of frequency domain subcarriers, the power of the transmit end, the noise power of the channel, and the lower limit of the received signal-to-noise ratio.

For example, the channel noise constraint condition is related to channel power and noise power in an entire channel restoration process and a signal-to-noise ratio (SNR) obtained through channel restoration. Formula (4) represents the channel power P_{H}, Formula (5) represents noise power P_{N} obtained through channel restoration, and Formula (6) represents the SNR obtained through channel restoration.

$${P}_{H} = E \{ trace ( {HH}^{H} ) \} = {SPP}_{TX} \qquad ( 4 )$$

$${P}_{N} = {σ}^{2} trace ( {{V}_{sub}}^{- 1} {{V}_{sub}}^{- H} ) \qquad ( 5 )$$

$${SNR}_{true} = \frac{{SPP}_{TX}}{{σ}^{2} trace ( {{V}_{sub}}^{- 1} {{V}_{sub}}^{- H} )} = {SNR}_{H} \frac{{SPP}_{TX}}{trace ( {{V}_{sub}}^{- 1} {{V}_{sub}}^{- H} )} \qquad ( 6 )$$

N represents the quantity of receive antennas, P represents the quantity of frequency domain subcarriers, P_{TX} represents the power of the transmit end, σ² represents the noise power of the channel, and SNR_{H} represents an original SNR of the channel.

For example, if a minimum received SNR threshold SNRₜₐᵣ exists in the communication system, the termination threshold that satisfies the minimum signal-to-noise ratio is shown in Formula (7):

$$S N {R}_{H} \frac{{SPP}_{TX}}{trace ( {V}_{sub}^{- 1} {V}_{sub}^{- H} )} \geq S N {R}_{tar} \qquad ( 7 )$$

$$\to trace ( {V}_{sub}^{- 1} {V}_{sub}^{- H} ) \leq {SPP}_{TX} \frac{S N {R}_{H}}{S N {R}_{tar}}$$

Different channel SNRs may correspond to different termination thresholds that satisfy the minimum signal-to-noise ratio. For example, according to Formula (7), if SNR_{H}=20 dB, the termination threshold that satisfies the minimum signal-to-noise ratio is

$$trace ( {V}_{sub}^{- 1} {V}_{sub}^{- H} ) \leq 1024 * 192 * 4 = 7.86 * {10}^{5} ;$$

or if SNR_{H}=30 dB, the termination threshold that satisfies the minimum signal-to-noise ratio is

$$trace ( {V}_{sub}^{- 1} {V}_{sub}^{- H} ) \leq 1024 * 192 * 4 * 10 = 7.86 * {10}^{6} .$$

Optionally, the channel noise constraint condition may be shown in Formula (3). In other words, the channel noise constraint condition is minimizing channel noise without considering the minimum received SNR threshold SNRₜₐᵣ.

The frequency domain position of the reference signal indicates a position of a frequency domain resource used for the reference signal. For example, the frequency domain resource may be divided into a plurality of frequency domain subcarriers, and a transmit end of the reference signal may send the reference signal by using one or more frequency domain subcarriers in frequency domain. The transmit antenna port of the reference signal indicates a position or an index of an air interface resource used for the reference signal. For example, a transmit end of the reference signal may include a plurality of transmit antenna ports, and the transmit end of the reference signal may send the reference signal through one or more transmit antenna ports.

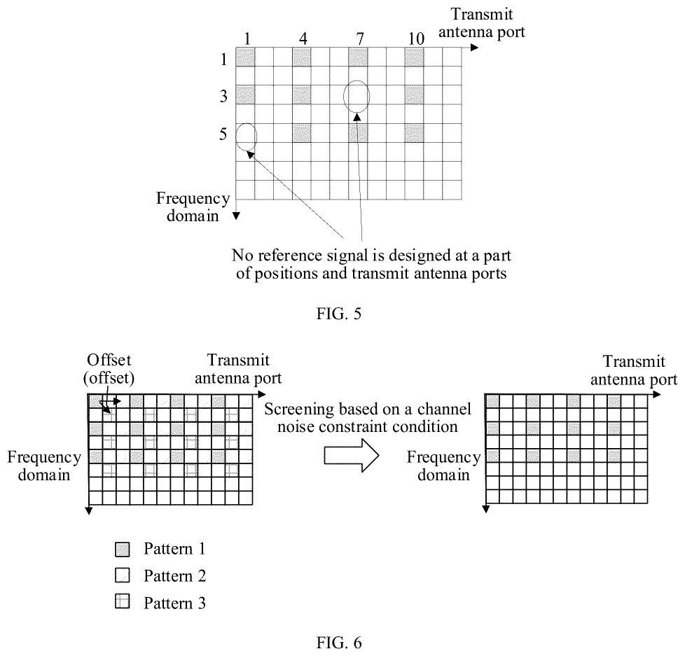

Optionally, frequency domain positions of the reference signal are partially continuous in a system bandwidth or a BWP allocated to a terminal device, and transmit antenna ports of the reference signal are partially continuous in a set including all transmit antenna ports. The system bandwidth is a maximum spectrum bandwidth used for data transmission in an entire cell, and the BWP is a subset of the system bandwidth, that is, a bandwidth part. For example, FIG. 5 is a diagram of a reference signal pattern. In FIG. 5, no reference signal is designed at a part of frequency domain positions in the system bandwidth (as shown in circular areas in FIG. 5), and the reference signal is designed at other continuous frequency domain positions (as shown in gray box areas in FIG. 5). In other words, the frequency domain positions of the reference signal are partially continuous in the system bandwidth. For another example, no reference signal is designed at a part of all transmit antenna ports in FIG. 5 (as shown in the circular areas in FIG. 5), and the reference signal is designed at other continuously numbered antenna ports (as shown in the gray box areas in FIG. 5). In other words, the transmit antenna ports of the reference signals are partially continuous in the set including all the transmit antenna ports.

Optionally, all frequency domain positions of the reference signal correspond to a same transmit antenna port, or some frequency domain positions of the reference signal correspond to a same transmit antenna port. For example, if all frequency domain positions of the reference signal correspond to transmit antenna ports with same numbers, the antenna port and the frequency domain position are regular; or if some frequency domain positions of the reference signal correspond to transmit antenna ports with same numbers, the antenna port and the frequency domain position may be considered to be regular.

In a possible implementation, the first apparatus may decompose a channel matrix to derive the channel noise constraint condition, and may obtain a candidate reference signal pattern based on the decomposition of the channel matrix. For example, FIG. 6 is a diagram of a candidate reference signal pattern. FIG. 6 includes three reference signal patterns, and each reference signal pattern includes the frequency domain position (a resource block on a vertical coordinate in FIG. 6) of the reference signal and a position or an index (a resource block on a horizontal coordinate in FIG. 6) of the transmit antenna port of the reference signal. The first apparatus may select, from the three reference signal patterns based on the channel noise constraint condition, a reference signal pattern that satisfies the channel noise constraint condition, to determine the frequency domain position and the transmit antenna port of the reference signal. For example, the first apparatus determines normalized channel noise based on the reference signal patterns. If the normalized channel noise is less than or equal to a noise threshold

$${NPP}_{TX} \frac{S N {R}_{H}}{S N {R}_{tar}} ,$$

the first apparatus determines that a frequency domain subcarrier and an antenna port in a reference signal pattern in which normalized channel noise is less than the noise threshold are the frequency domain position and the transmit antenna port of the reference signal. Alternatively, if the normalized channel noise is greater than a noise threshold, the first apparatus may adjust the channel noise constraint condition (for example, increase a quantity of transmit antenna ports or the quantity of subcarriers) until the normalized channel noise is less than or equal to the noise threshold.

S102: The first apparatus sends first indication information to the second apparatus, where the first indication information indicates the frequency domain position and the transmit antenna port of the reference signal.

The first apparatus may indicate, to the second apparatus by using the first indication information, the frequency domain position and the transmit antenna port for sending the reference signal. For example, the first indication information includes an index of a reference signal pattern. Correspondingly, the second apparatus receives the index of the reference signal pattern, and may determine the frequency domain position and the transmit antenna port for sending the reference signal. For another example, the first indication information includes the frequency domain position and an index of the transmit antenna port of the reference signal. Correspondingly, the second apparatus receives the frequency domain position and the index of the transmit antenna port of the reference signal, and may determine the frequency domain position and the transmit antenna port of the reference signal.

### III. The Following Describes a Specific Procedure of S101 in Detail

Example 1: The first apparatus decomposes the channel matrix, and performs iteration based on the channel noise constraint condition, to determine an orthogonal basis matrix that satisfies the channel noise constraint condition. A column vector of the orthogonal basis matrix represents the frequency domain position and the transmit antenna port of the reference signal.

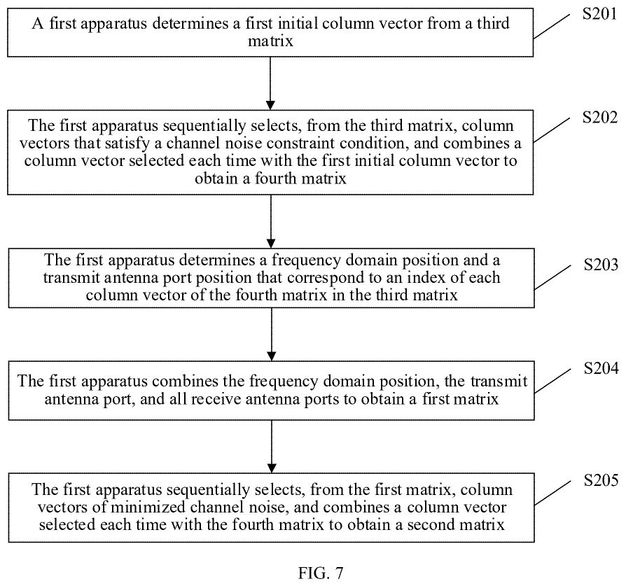

For example, FIG. 7 is a schematic flowchart in which the first apparatus determines a reference signal pattern based on the channel matrix and the channel noise constraint condition according to this application. The following steps are included.

S201: The first apparatus determines a first initial column vector from a third matrix.

The third matrix is a three-dimensional matrix including all the transmit antenna ports, all receive antenna ports, and all frequency domain positions. For example, the third matrix is represented as VK, and VK is an R2*NMP matrix. R2 is a rank of VK, N represents a quantity of receive antenna ports, M represents a quantity of transmit antenna ports, and P represents a quantity of frequency domain subcarriers in the entire system bandwidth or the BWP. For a source of VK, refer to corresponding descriptions in step 1 to step 3 in FIG. 2. In other words, the third matrix is determined by the first apparatus based on a three-dimensional matrix/tensor of the transmit antenna port, the receive antenna port, and the frequency domain subcarrier.

Optionally, the first apparatus may randomly select a column vector from the third matrix as the first initial column vector. The first initial column vector is a column vector including an index of a transmit antenna port and a position of a frequency domain subcarrier.

Optionally, the first apparatus may select, from the third matrix, a column vector that satisfies a maximized trace of an antenna port-frequency domain orthogonal basis matrix as the first initial column vector. For example, the first apparatus may select the first initial column vector based on a constraint condition shown in Formula (8):

$$max {σ}^{2} trace ( {V}_{sub}^{H} {V}_{sub} ) \qquad ( 8 )$$

Formula (8) is a corresponding variation of Formula (3) when V_{sub} is a vector, and represents the maximized trace of the antenna port-frequency domain orthogonal basis matrix, that is, represents the minimized channel noise.

S202: The first apparatus sequentially selects, from the third matrix, column vectors that satisfy the channel noise constraint condition, and combines a column vector selected each time with the first initial column vector to obtain a fourth matrix.

A column vector dimension of the fourth matrix satisfies a preset maximum expected carrier quantity and transmit antenna port quantity. For example, the fourth matrix is represented as

$${V}_{sub}^{′} ,$$

the column vector dimension of

$${V}_{sub}^{′}$$

is R3*R2 (for example,

$${V}_{sub}^{′} = {C}^{R 3 * R 2} ) ,$$

R3 represents the maximum expected quantities of carriers and transmit antenna ports, and R3≤R2. C represents a column vector of the fourth matrix.

For example, the channel noise constraint condition is shown in Formula (3), and the preset maximum expected carrier quantity and transmit antenna port quantity are R3. In this case, the first apparatus may search the third matrix VK for a column vector that satisfies Formula (3), and perform iteration. A column vector (represented as New column) may be obtained through each search, and column vector combination is performed again on the column vector and a matrix obtained through a previous iteration, as shown in Formula (9):

$${V}_{sub}^{′} = {V}_{sub}^{t = R 3} \qquad ( 9 )$$

$${V}_{sub}^{t} = [ \begin{matrix}{V}_{sub}^{t - 1} \\ New column\end{matrix} ]$$

t represents a current quantity of iterations, and

$${V}_{sub}^{t - 1}$$

represents the matrix obtained through the previous iteration. If the iteration reaches

$${V}_{sub}^{′} = {C}^{R 3 * R 2} ,$$

the first apparatus stops the iteration, and completes initial search.

S203: The first apparatus determines a frequency domain position and a transmit antenna port position that correspond to an index of each column vector of the fourth matrix in the third matrix.

The first apparatus may determine the index of each column vector of the fourth matrix in the third matrix based on a search result in S202. For example, if a plurality of column vectors of the fourth matrix correspond to a plurality of index values in the third matrix (for example, a 1^{st} column of the fourth matrix corresponds to a 2nd column in the third matrix, and a 2nd column corresponds to a 4^{th} column in the third matrix), the first apparatus may select a corresponding column vector from the third matrix to obtain a frequency domain position and a transmit antenna port position included in each column vector.

S204: The first apparatus combines the frequency domain position, the transmit antenna port, and all the receive antenna ports to obtain a first matrix.

S205: The first apparatus sequentially selects, from the first matrix, column vectors of the minimized channel noise, and combines a column vector selected each time with the fourth matrix to obtain a second matrix.

The first apparatus may reconstruct a new orthogonal basis matrix, that is, the first matrix VK_{sub}, based on the frequency domain position and the transmit antenna port that are determined in S203. A column vector dimension of the second matrix V_{sub}=C^{R2*R2} satisfies the rank R2 of the third matrix, and satisfies the channel noise constraint condition. It may be understood that a column vector of the second matrix includes the frequency domain position and the transmit antenna port of the reference signal. In other words, the second matrix corresponds to the reference signal pattern.

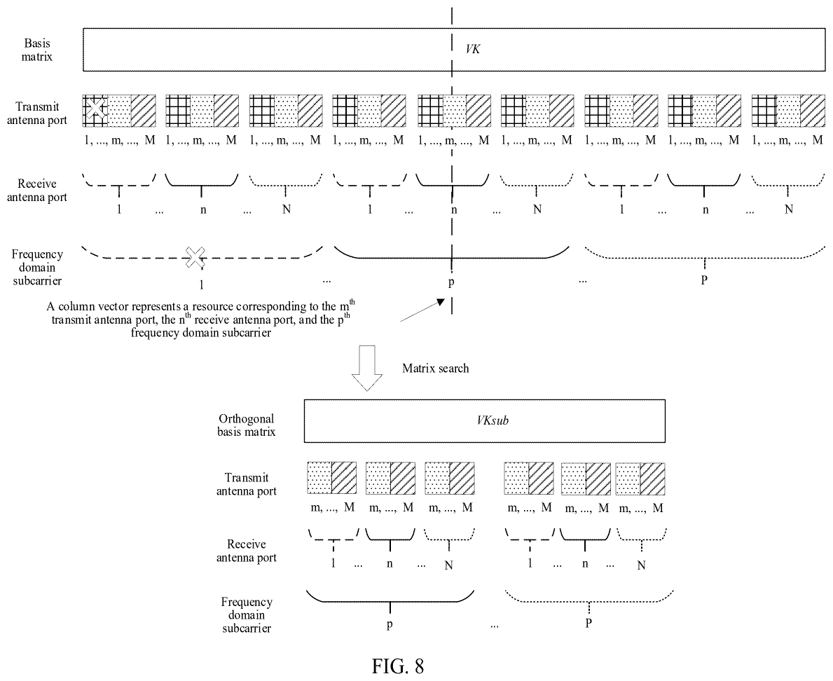

For example, FIG. 8 is a diagram in which the first apparatus obtains the second matrix according to this application. VK includes the transmit antenna port, the receive antenna port, and the frequency domain subcarrier. Further, VK includes: M transmit antenna ports in total, where 1, . . . , m, . . . , M represents all transmit antenna ports from a 1^{st} transmit antenna port to an M^{th} transmit antenna port; N receive antenna ports in total, where 1, . . . , n, . . . , N represents all receive antenna ports from a 1^{st} receive antenna port to an N^{th} receive antenna port; and P frequency domain subcarriers in total, where 1, . . . , p, . . . , P represents all frequency domain subcarriers from a 1^{st} frequency domain subcarrier to a P^{th} frequency domain subcarrier. It can be further derived from FIG. 8 that all the transmit antenna ports from the 1^{st} transmit antenna port to the M^{th} transmit antenna port may correspond to the 1^{st} receive antenna port and the 1^{st} frequency domain subcarrier, and so on. All the transmit antenna ports from the 1^{st} transmit antenna port to the M^{th} transmit antenna port correspond to the n^{th} receive antenna port and the 1^{st} frequency domain subcarrier, and so on. All the transmit antenna ports from the 1^{st} transmit antenna port to the M^{th} transmit antenna port correspond to the N^{th} receive antenna port and the 1^{st} frequency domain subcarrier. Optionally, for another receive antenna port and frequency domain subcarrier, there is a similar correspondence. Details are not described herein. A column vector of VK represents a resource corresponding to the m^{th} transmit antenna port, the n^{th} receive antenna port, and the p^{th} frequency domain subcarrier.

For example, assuming that the first apparatus determines, based on the preset maximum expected carrier quantity and transmit antenna port quantity during matrix search, that a transmit antenna port 1 and a frequency domain subcarrier 1 are unavailable, the first apparatus searches entire IK for a column vector that satisfies Formula (3), and performs iteration until the iteration reaches

$${V}_{sub}^{′} = {C}^{R 3 * R 2} .$$

Further, the first apparatus reconstructs VK_{sub} based on indexes that are of a transmit antenna port and a frequency domain subcarrier and that correspond to each column vector of

$${V}_{sub}^{′} = {C}^{R 3 * R 2}$$

in VK, as shown in FIG. 8 (for example, VK_{sub} does not include a column vector that corresponds to the transmit antenna port 1 and the frequency domain subcarrier 1). The first apparatus continues to perform matrix search and iteration based on VK_{sub}, and finally determines the second matrix V_{sub}=C^{R2*R2}.

Optionally, in this application, when the frequency domain position and the transmit antenna port of the reference signal are determined, the channel noise constraint condition may not be considered. For example, the first apparatus continues to perform matrix search and iteration based on VK_{sub}, and may consider the formula of the minimized channel noise. In other words, the first apparatus searches entire VK_{sub} for the column vector that satisfies Formula (3), and performs iteration until the iteration reaches V_{sub}=C^{R2*R2}. Alternatively, when the first apparatus continues to perform matrix search and iteration based on VK_{sub}, a column vector that does not satisfies Formula (3) may also be used as a column vector of V_{sub}.

Example 2: The first apparatus determines a first matrix based on a preset reference signal pattern limitation condition, and performs iteration based on the channel noise constraint condition, to determine an orthogonal basis matrix that satisfies the channel noise constraint condition. A column vector of the orthogonal basis matrix represents the frequency domain position and the transmit antenna port of the reference signal.

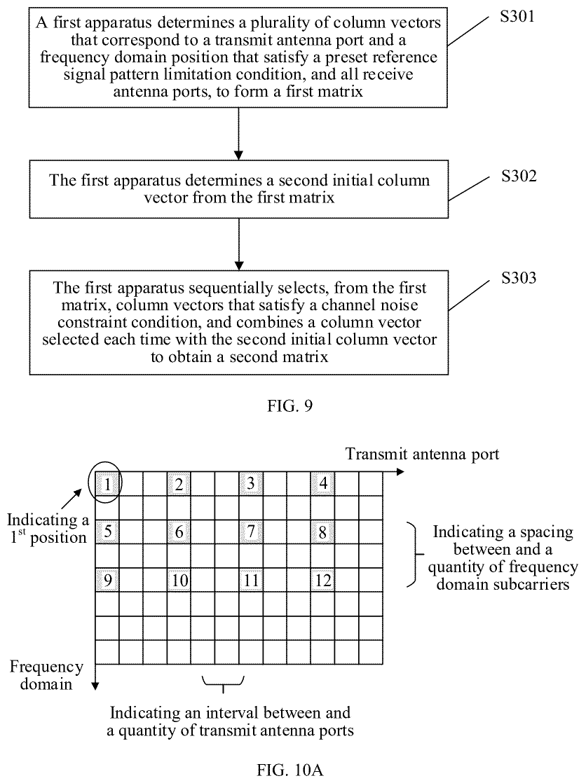

For example, FIG. 9 is a schematic flowchart in which the first apparatus determines a reference signal pattern based on the preset reference signal pattern limitation condition and the channel noise constraint condition according to this application. The following steps are included.

S301: The first apparatus determines a plurality of column vectors that correspond to a transmit antenna port and a frequency domain position that satisfy the preset reference signal pattern limitation condition, and all the receive antenna ports, to form the first matrix.

The preset reference signal pattern limitation condition includes one or more of the following: an interval between transmit antenna ports, a spacing between frequency domain subcarriers, a maximum quantity of transmit antenna ports, and a maximum quantity of frequency domain subcarriers. For example, it is assumed that the preset reference signal pattern limitation condition includes: a spacing S1=2 between transmit antenna ports, a spacing S2=1 between frequency domain subcarriers, a maximum quantity N1=3 of transmit antenna ports, and a maximum quantity N2=2 of frequency domain subcarriers. The first apparatus determines a plurality of candidate reference signal patterns based on the preset reference signal pattern limitation condition, for example, the plurality of reference signal patterns shown in FIG. 6. It may be understood that the plurality of column vectors that correspond to the transmit antenna port and the frequency domain position that satisfy the preset reference signal pattern limitation condition, and all the receive antenna ports form the first matrix VK_{sub}. In other words, the plurality of reference signal patterns corresponds to the first matrix VK_{sub}.

S302: The first apparatus determines a second initial column vector from the first matrix.

Optionally, the first apparatus may randomly select a column vector from the first matrix as the second initial column vector. The second initial column vector is a column vector including an index of a transmit antenna port and a position of a frequency domain subcarrier.

Optionally, the first apparatus may select, from the first matrix, a column vector that satisfies a maximized trace of an antenna port-frequency domain orthogonal basis matrix as the second initial column vector. For example, the first apparatus may select the second initial column vector based on the constraint condition shown in Formula (8), in other words, select the second initial column vector of the minimized channel noise.

S303: The first apparatus sequentially selects, from the first matrix, column vectors that satisfy the channel noise constraint condition, and combines a column vector selected each time with the second initial column vector to obtain a second matrix.

For example, the first apparatus may select, from the plurality of reference signal patterns shown in FIG. 6 based on the channel noise constraint condition, a reference signal pattern that satisfies the channel noise constraint condition, to determine the frequency domain position and the transmit antenna port of the reference signal. Optionally, if normalized channel noise that corresponds to the reference signal pattern is greater than the noise threshold, the first apparatus may adjust the channel noise constraint condition (for example, increase the quantity of transmit antenna ports or the quantity of subcarriers) until the normalized channel noise that corresponds to the reference signal pattern is less than or equal to the noise threshold. Optionally, the first apparatus sequentially selects, from the first matrix, column vectors that satisfy the channel noise constraint condition, and performs column vector combination again on the column vector and a matrix obtained through a previous iteration. This may alternatively be performed with reference to Formula (9).

### IV. The Following Describes a Specific Procedure of S102 in Detail

Example 1: The first apparatus sends, to the second apparatus, indexes of different reference signal patterns, or a combination of an index of a reference signal pattern and an offset.

For example, if the first apparatus determines a second matrix by using the method for presetting a reference signal pattern and optimizing iteration described in Example 2 of Section III, the first apparatus sends, to the second apparatus, an index of a reference signal pattern corresponding to the second matrix. For example, indexes of the three candidate reference signal patterns shown in FIG. 6 are respectively a pattern 1, a pattern 2, and a pattern 3. If the pattern 1 satisfies the channel noise constraint condition, the first apparatus may send the pattern 1 to the second apparatus. Correspondingly, the second apparatus may obtain the corresponding reference signal pattern based on the index. It may be understood that, in Example 1, the first apparatus needs only a small quantity of indication overheads to indicate the index of the reference signal pattern (where for example, the indication overheads are far less than indication overheads of a position of the reference signal).

For another example, the first apparatus sends a combination of an index of a reference signal pattern 1 and an offset to the second apparatus. A pattern 2 may be considered as a pattern obtained by shifting the pattern 1 with a frequency domain offset of 0 and a space domain offset of 2 in an offset 1. A pattern 3 may be considered as a pattern obtained by shifting the pattern 1 with a frequency domain offset of 1 and a space domain offset of 1 in an offset 2. If the first apparatus sends the index of the reference signal pattern 1 and the offset 1 to the second apparatus, the second apparatus may determine that the reference signal pattern is the pattern 2. Optionally, the three patterns in FIG. 6 may also be considered as different patterns (for example, which are not obtained by shifting based on an offset).

Example 2: The first apparatus sends a rule of the reference signal pattern to the second apparatus.

In a possible implementation, the rule of the reference signal pattern may include one or more of the following: a 1^{st} position of the reference signal pattern on a frequency domain subcarrier and a transmit antenna port, a spacing between frequency domain subcarriers in the reference signal pattern, an interval between transmit antenna ports in the reference signal pattern, a quantity of frequency domain subcarriers in the reference signal pattern, and a quantity of transmit antenna ports in the reference signal pattern.

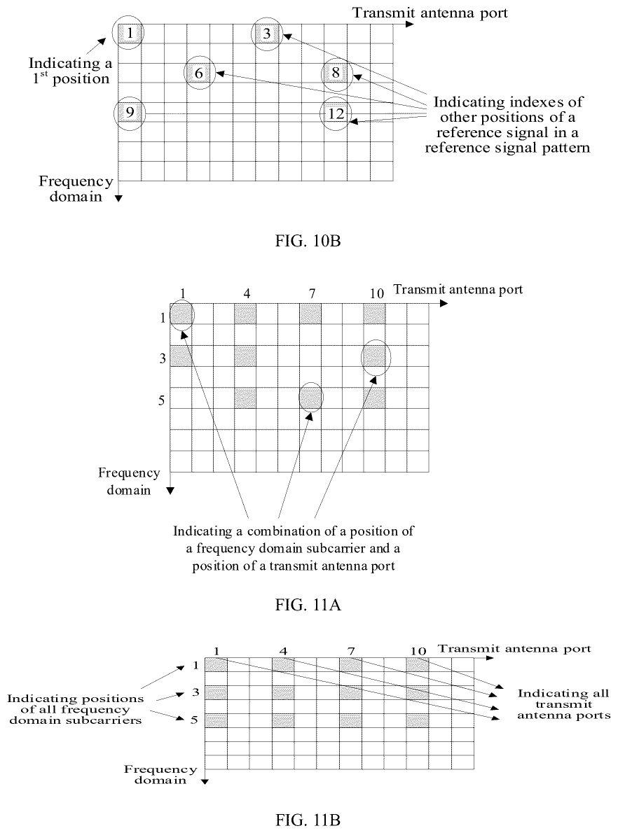

For example, FIG. 10A is a diagram of a rule of a reference signal pattern according to this application. The rule of the reference signal pattern includes a 1^{st} position of the reference signal pattern on a frequency domain subcarrier and a transmit antenna port, a spacing between frequency domain subcarriers in the reference signal pattern, an interval between transmit antenna ports in the reference signal pattern, a quantity of frequency domain subcarriers in the reference signal pattern, and a quantity of transmit antenna ports in the reference signal pattern. Correspondingly, the second apparatus receives the rule of the reference signal pattern, and may restore, according to the rule, the reference signal pattern shown in FIG. 10A, to determine the frequency domain position and the transmit antenna port for sending the reference signal. Optionally, if the first apparatus indicates only the 1^{st} position of the reference signal pattern on the frequency domain subcarrier and the transmit antenna port, the quantity of frequency domain subcarriers of the reference signal pattern, and the quantity of transmit antenna ports of the reference signal pattern, the second apparatus may also restore the reference signal pattern, to determine the frequency domain position and the transmit antenna port for sending the reference signal.

In another possible implementation, the rule of the reference signal pattern includes a 1^{st} position of the reference signal pattern on a frequency domain subcarrier and a transmit antenna port, and/or an index of another reference signal position in the reference signal pattern.

For example, FIG. 10B is a diagram of a rule of another reference signal pattern according to this application. The rule of the reference signal pattern includes a 1^{st} position of the reference signal pattern on a frequency domain subcarrier and a transmit antenna port, and indexes (as shown by positions 3, 6, 8, 9, and 12 in FIG. 10B) of other reference signal positions in the reference signal pattern. This indication manner is applicable to indicating an irregular reference signal pattern.

It may be understood that, in Example 2, the first apparatus needs only a small quantity of indication overheads to indicate the rule of the reference signal pattern (where for example, the indication overheads are far less than overheads for directly indicating a position of the reference signal).

Example 3: The first indication information includes a position of a frequency domain subcarrier and/or an index of the transmit antenna port.

For example, if the first apparatus determines a second matrix by using the matrix decomposition and iteration method described in Example 1 of section III, the first apparatus may send the position of the frequency domain subcarrier and/or the index of the transmit antenna port to the second apparatus.

In a possible implementation, the first indication information includes an index of a column vector of the second matrix in a first matrix or a third matrix. For example, N represents a quantity of receive antenna ports, M represents a quantity of transmit antenna ports, P represents a quantity of frequency domain subcarriers, and the index of the column vector of the second matrix in the first matrix or the third matrix satisfies Formula (10):

$$index = ( p - 1 ) * MN + ( n - 1 ) * M + m \qquad ( 10 )$$

$$1 \leq p \leq P , 1 \leq m \leq M , 1 \leq n \leq N$$

p represents an index of a p^{th} frequency domain subcarrier, m represents an index of an m^{th} transmit antenna port, and n represents an index of an n^{th} receive antenna port.

In a possible implementation, the first apparatus sends, to the second apparatus, a combination that is of a frequency domain position and a transmit antenna port position and that corresponds to an index of a column vector of the second matrix in a first matrix. For example, FIG. 11A is a diagram of a combination of a frequency domain position and a transmit antenna port position according to this application. The first apparatus may indicate, to the second apparatus, each combination of a frequency domain position and a transmit antenna port position of the reference signal, for example, indicate a combination of a frequency domain subcarrier 1 and a transmit antenna port position 1, and a combination of a frequency domain subcarrier 3 and a transmit antenna port position 10, as shown in FIG. 11A.

In another possible implementation, the first apparatus sends, to the second apparatus, all frequency domain positions and all transmit antenna ports that correspond to an index of a column vector of the second matrix in a first matrix. For example, FIG. 11B is another diagram of separately indicated positions of a frequency domain position and a transmit antenna port according to this application. The first apparatus may indicate, to the second apparatus, all frequency domain positions and positions of transmit antenna ports of the reference signal, for example, indicate positions of frequency domain subcarriers 1, 3, and 5 and transmit antenna ports 1, 4, 7, and 10. Then, the second apparatus sends the reference signal at all possible combined positions, as shown in FIG. 11B. It may be understood that, in a reference signal pattern shown in FIG. 11B, all frequency domain positions for sending the reference signal correspond to transmit antenna ports with same numbers. In this case, a reference signal pattern determined by the first apparatus is regular, and a reference signal pattern indicated to the second apparatus is also regular.

It may be understood that, in the foregoing two implementations, the first apparatus needs to directly indicate a position combination for the reference signal, for example, indicate the combination of the frequency domain position and the transmit antenna port position of the reference signal. In this case, indication overheads are increased compared with indication overheads in Example 1 and Example 2. However, because the position combination for sending the reference signal is directly indicated, it is beneficial for the second apparatus to clearly send the reference signal at the corresponding position combination, and for the first apparatus to clearly receive the reference signal at the corresponding position combination, to help improve transmission performance.

Example 4: The first apparatus separately indicates a position of a frequency domain subcarrier and an index of the transmit antenna port to the second apparatus.

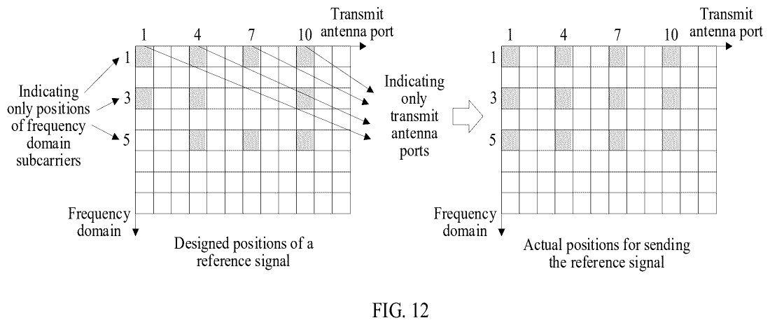

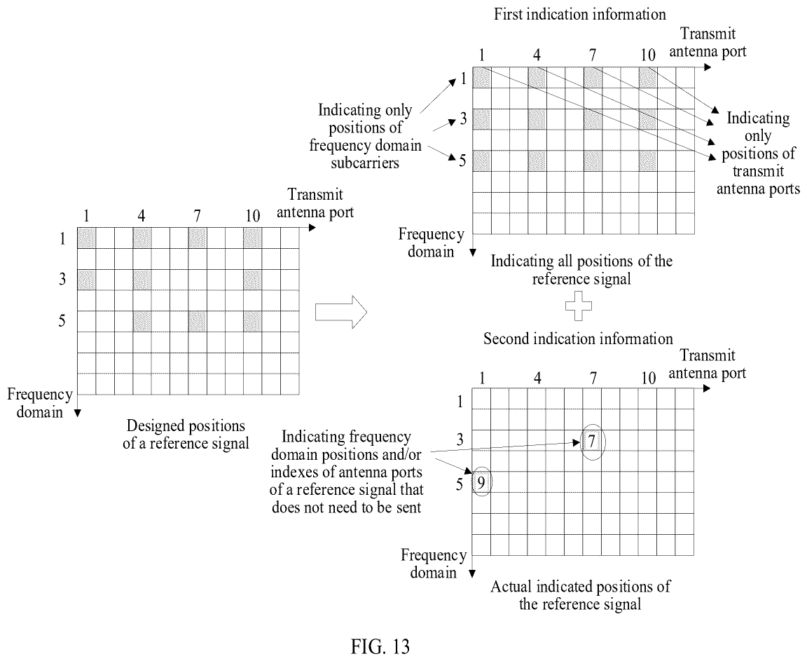

For example, FIG. 12 is a diagram of separately indicating the position of the frequency domain subcarrier and the index of the transmit antenna port according to this application. The first apparatus separately indicates the position of the frequency domain subcarrier and the index of the transmit antenna port to the second apparatus by using two different pieces of control signaling. Correspondingly, the second apparatus combines, based on the control signaling, the frequency domain position and the transmit antenna port to determine a position for sending the reference signal, so that the second apparatus can send the reference signal to the first apparatus at all corresponding positions of the reference signal.

Optionally, after the second apparatus combines the indicated position of the frequency domain subcarrier and the indicated index of the transmit antenna port, the combination may not correspond to a regular reference signal pattern. For example, a reference pattern rule determined by the first apparatus is shown on a left side of FIG. 12. A part of frequency domain positions that are for sending the reference signal and that are in the reference signal pattern correspond to transmit antenna ports with same numbers. For example, frequency domain subcarriers 1 and 3 correspond to transmit antenna ports 1, 4, and 10, and frequency domain subcarriers 1 and 5 correspond to transmit antenna ports 4, 7, and 10. In this case, the reference signal pattern is partially regular, and a reference signal pattern indicated by the first apparatus to the second apparatus is also partially regular. However, the second apparatus may supplement a part of frequency domain positions and transmit antenna ports that are not indicated to obtain a regular reference signal pattern (as shown on a right side of FIG. 12), and send the reference signal at positions of the supplemented regular reference signal pattern. It may be understood that, in Example 4, a quantity of resources used for sending the reference signal is increased (for example, the reference signal is sent at the positions of the supplemented regular reference signal pattern), but corresponding indication overheads are reduced (where there is no need to indicate a plurality of position combinations, but the position of the frequency domain subcarrier and the index of the transmit antenna port are separately indicated, and then the second apparatus arranges and combines the information).

In a possible implementation, the first apparatus may send second indication information to the second apparatus. The second indication information indicates a frequency domain position or an index not for sending the reference signal, and/or an index of a transmit antenna port not for sending the reference signal. For example, FIG. 13 is a diagram of the first indication information and the second indication information according to this application. A reference signal pattern designed by the first apparatus may not correspond to a regular reference signal pattern (as shown on a left side of FIG. 13). In this case, the first apparatus may separately indicate the position of the frequency domain subcarrier and the index of the transmit antenna port to the second apparatus, and may indicate, to the second apparatus, the frequency domain position or the index not for sending the reference signal, and/or the index of the transmit antenna port not for sending the reference signal, as shown on a right side of FIG. 13. Optionally, if a reference signal pattern indicated by the first indication information is very sparse (in other words, positions for sending the reference signal is a subset of a regular pattern and a quantity of positions is small), the second indication information indicates a frequency domain position or an index for sending the reference signal, and/or an index of a transmit antenna port for sending the reference signal. For example, assuming that there is only a frequency domain subcarrier 1, a transmit antenna port 1, a frequency domain subcarrier 3, and a transmit antenna port 4 on the left of FIG. 13, the reference signal pattern is very sparse. In this case, the second indication information indicates the frequency domain subcarrier 1 and the transmit antenna port 1 for sending the reference signal, and the frequency domain subcarrier 3 and the transmit antenna port 4 for sending the reference signal. It may be understood that, in this implementation, only a small amount of control signaling (the second indication information) needs to be added to accurately indicate a small quantity of positions for sending (or not for sending) the reference signal, so that a quantity of resources for sending the reference signal is reduced.

### V. When a First Apparatus is a Network Device, and a Second Apparatus is a Terminal Device, it is Assumed that the Second Apparatus Determines a Reference Signal Pattern, and Sends the Reference Signal Pattern and a Reference Signal to the First Apparatus

Example 1: It is assumed that the first apparatus decomposes a channel matrix to obtain a third matrix and a SNR, and sends the third matrix and the SNR to the second apparatus, so that the second apparatus can determine the reference signal pattern based on the third matrix and the SNR.

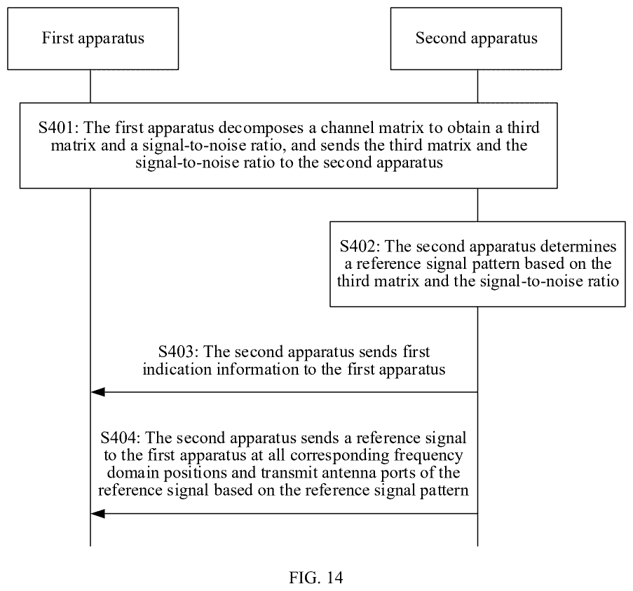

For example, FIG. 14 is a schematic flowchart in which the second apparatus determines the reference signal pattern and sends the reference signal pattern and the reference signal to the first apparatus according to this application. The procedure is implemented through interaction between the first apparatus and the second apparatus, and includes the following steps.

S401: The first apparatus decomposes the channel matrix to obtain the third matrix and the signal-to-noise ratio, and sends the third matrix and the signal-to-noise ratio to the second apparatus.

For example, the first apparatus decomposes the channel matrix, and may obtain the third matrix VK including all transmit antenna ports, all receive antenna ports, and all frequency domain positions. The first apparatus may further determine the SNR according to Formula (6). Then, the first apparatus may send the third matrix VK and the SNR to the second apparatus.

S402: The second apparatus determines the reference signal pattern based on the third matrix and the signal-to-noise ratio.

For example, the second apparatus may determine the reference signal pattern (that is, determine a frequency domain position and a transmit antenna port of the reference signal) based on the third matrix and the SNR by using the method for determining the reference signal pattern described in the embodiment in FIG. 7 or FIG. 9. For a specific implementation, refer to the foregoing corresponding descriptions. Details are not described herein again.

S403: The second apparatus sends first indication information to the first apparatus.

For example, the second apparatus may send indexes of different reference signal patterns, a rule of the reference signal pattern, or the like to the first apparatus. For a specific implementation, refer to descriptions in the examples in Section IV. Details are not described herein again.

S404: The second apparatus sends the reference signal to the first apparatus at all corresponding frequency domain positions and transmit antenna ports of the reference signal based on the reference signal pattern.

For example, the reference signal pattern determined by the second apparatus is shown in FIG. 10A. The second apparatus may send the reference signal at all possible combined positions of frequency domain subcarriers 1, 3, and 5 and transmit antenna ports 1, 4, 7, and 10 that correspond to the reference signal pattern, that is, send the reference signal at all gray positions shown in FIG. 10A.

Example 2: It is assumed that the second apparatus decomposes a channel matrix to obtain a third matrix and a signal-to-noise ratio SNR, and determines the reference signal pattern based on the third matrix and the SNR.

Different from Example 1 shown in FIG. 14, in Example 2, the second apparatus may decompose the channel matrix to obtain the third matrix and the signal-to-noise ratio. In other words, the second apparatus may decompose the channel matrix, and may obtain the third matrix VK including all transmit antenna ports, all receive antenna ports, and all frequency domain positions. The second apparatus may further determine the SNR according to Formula (6). Therefore, the first apparatus may not send the third matrix or the signal-to-noise ratio to the second apparatus.

Optionally, other steps in Example 2 are the same as those in Example 1. For example, Example 2 also includes S402 to S404. For a specific implementation, refer to corresponding descriptions in Example 1. Details are not described herein again.

### VI. The Following Analyzes Performance of the Communication Method Provided in this Application

For example, Table 1 is a link simulation parameter table corresponding to the communication method provided in this application. In this application, it is assumed that a 10 gigahertz urban microcellular area non-line-of-sight (10G-UMA-NLOS) channel model is used, and a simulation scenario is configured with reference to Table 1. It should be noted that an SRS is used as an example of a reference signal in the following simulation analysis.

TABLE 1
Link simulation parameter table
Simulation parameters

| Parameters | Values |
|---|---|
| Scenarios | One network device and One terminal device |
| | 1 BS and 1 UE |
| Channel model | Refer to the 10G-UMA-NLOS channel model in |
| | 3rd Generation Partnership Project (3GPP) |
| | Technical Specification (TS) 38.901. |
| Carrier frequency | 10 GHz, 30 kilohertz (kHz) a subcarrier spacing |
| | (scs) |
| Bandwidth | 16 resource blocks (RBs)/32 RBs |
| Channel assumption | NLOS channel |
| Transmit antenna port | 32: (M, N, P) = (4, 4, 2); and (dH, dV) = |
| configuration | (0.5, 0.5)λ |
| UE antenna config | |
| Receive antenna port | 1024: (M, N, P) = (8, 64, 2); and (dH, dV) = |
| configuration | (0.5, 0.5)λ |
| BS antenna config | |
| Standard channel | 460 paths: 23 clusters and 20 rays |
| Downlink (DL) | Resource element (RE) level |
| precoding level | |
| Uplink (UL) SNR | 20 decibels (dB) |
| DL SNR | 20 dB |

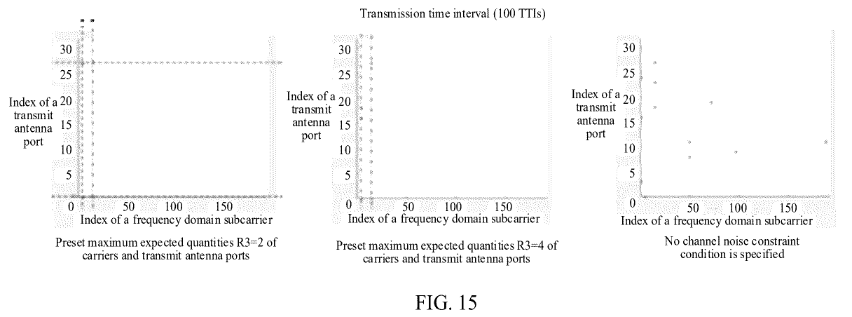

For example, FIG. 15 is a diagram of simulation of a reference signal pattern that is carried by 16 resource blocks and that is designed based on minimum noise according to this application. In the simulation condition and the 10G-UMA-NLOS channel shown in Table 1, a reference signal pattern obtained through channel matrix decomposition and noise minimization design in the communication method provided in this application is shown in FIG. 15. It is assumed that there are 16 frequency domain resource blocks RBs. It can be learned from FIG. 15 that, when no channel noise constraint condition is specified, distribution of a reference signal pattern obtained through QR decomposition is irregular and unordered in frequency domain and on antenna ports. The reference signal pattern designed by using the communication method in this application needs fewer RE resources and is more regular in frequency domain and on antenna ports (where the RE resources are basically located in a dashed line area in FIG. 15).

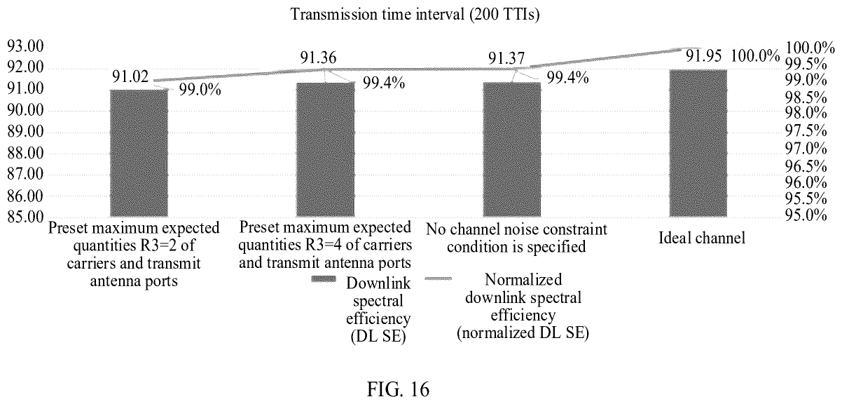

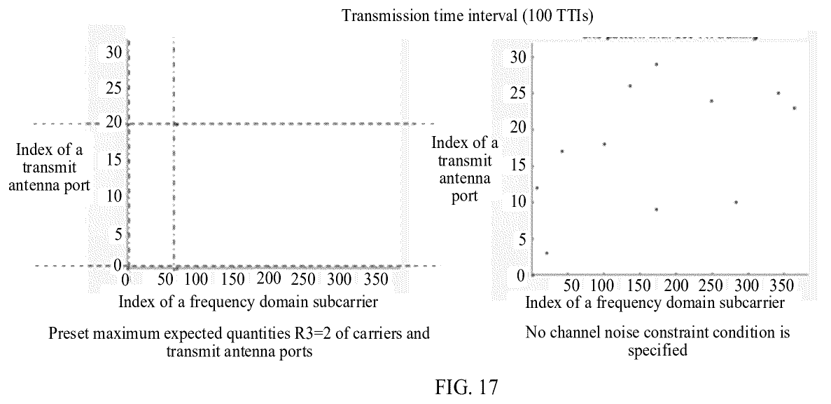

For example, FIG. 16 is a diagram of simulation of downlink spectral efficiency of a reference signal carried by 16 resource blocks according to this application. The downlink spectral efficiency is directly proportional to accuracy of uplink channel estimation. It is assumed that there are 16 frequency domain resource blocks RBs. It can be learned from FIG. 16 that the reference signal pattern designed by using the communication method in this application becomes more regular, and a loss of the downlink spectral efficiency does not exceed 1%.

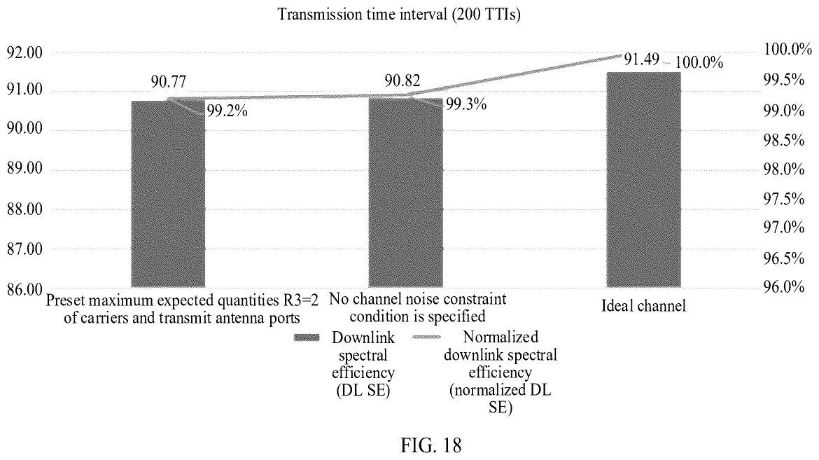

For example, FIG. 17 is a diagram of simulation of a reference signal pattern carried by 32 resource blocks according to this application. FIG. 18 is a diagram of simulation of downlink spectral efficiency of a reference signal carried by 32 resource blocks according to this application. It is assumed that there are 32 frequency domain resource blocks RBs. It can be learned from comparison between FIG. 17 and FIG. 15 and comparison between FIG. 18 and FIG. 16 that, even though a frequency domain bandwidth is doubled, the reference signal pattern designed in this application is still relatively regular, and a loss of downlink spectral efficiency is very low.

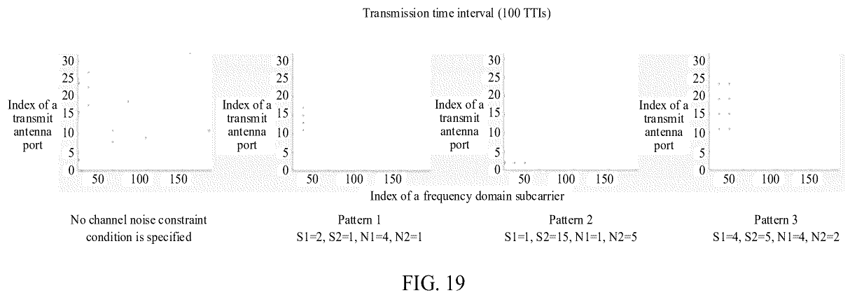

For example, FIG. 19 is a diagram of simulation of a fixed reference signal pattern according to this application. A preset reference signal pattern limitation condition that corresponds to a pattern 1 includes: a spacing S1=2 between transmit antenna ports, a spacing S2=1 between frequency domain subcarriers, a maximum quantity N1=4 of transmit antenna ports, and a maximum quantity N2=1 of frequency domain subcarriers. Similarly, a preset reference signal pattern limitation condition that corresponds to a pattern 2 includes: S1=1, S2=15, N1=1, and N2=5; and a preset reference signal pattern limitation condition that corresponds to a pattern 3 includes: S1=4, S2=5, N1=4, and N2=2. It can be learned from FIG. 19 that, compared with a method in which no channel noise constraint condition is specified, the reference signal pattern designed in this application is regular. For example, in the pattern 1, a plurality of transmit antenna ports are evenly distributed on one subcarrier; in the pattern 2, a plurality of frequency domain subcarriers is evenly distributed on one transmit antenna port; and in the pattern 3, a plurality of frequency domain subcarriers and a plurality of transmit antenna ports are evenly distributed.

For example, Table 2 is a downlink spectral efficiency table of the fixed reference signal pattern provided in this application. It is assumed that there are 16 frequency domain resource blocks RBs. Table 2 shows channel normalized mean square errors and downlink average spectral efficiency that are obtained after reference signal patterns provided in this application that are designed based on different preset reference signal pattern limitation conditions and a reference signal pattern designed when no channel noise constraint condition is specified are used for channel estimation.

TABLE 2
Downlink spectral efficiency table of
the fixed reference signal pattern

| | | Preset | Preset | Preset |
|---|---|---|---|---|
| | No channel | reference | reference | reference |
| | noise | signal | signal | signal |
| | constraint | pattern | pattern | pattern |
| | condition is | limitation | limitation | limitation |
| | specified | condition 1 | condition 2 | condition 3 |
| Channel | 0.25% | 0.32% | 0.34% | 0.29% |
| normalized | | | | |
| mean square | | | | |
| error | | | | |
| Downlink | 91.37 | 91.33 | 91.16 | 91.33 |
| average | | | | |
| spectral | | | | |
| efficiency | | | | |

It can be learned from Table 2 that downlink average spectral efficiency that corresponds to the reference signal patterns provided in this application that are designed based on different preset reference signal pattern limitation conditions and downlink average spectral efficiency that corresponds to the reference signal pattern designed when no channel noise constraint condition is specified are basically the same.

To implement functions in the method provided in this application, the apparatus or the device provided in this application may include a hardware structure and/or a software module, and implement the foregoing functions in a form of the hardware structure, the software module, or a combination of the hardware structure and the software module. Whether a function in the foregoing functions is performed by using the hardware structure, the software module, or the combination of the hardware structure and the software module depends on particular applications and design constraint conditions of the technical solutions. Division into modules in this application is an example, is merely logical function division, and may be other division during actual implementation. In addition, functional modules in embodiments of this application may be integrated into one processor, or may exist alone physically, or two or more modules may be integrated into one module. The integrated module may be implemented in a form of hardware, or may be implemented in a form of a software functional module.

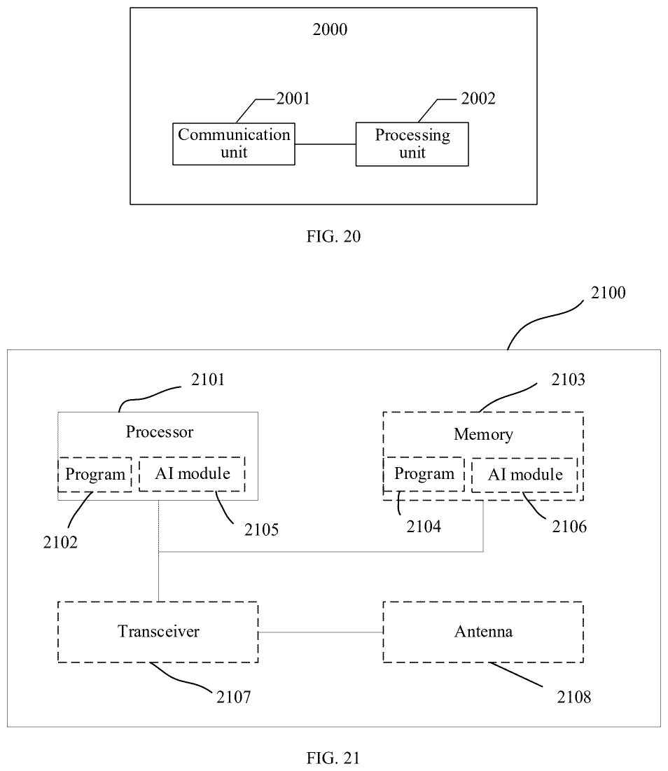

FIG. 20 is a diagram of a communication apparatus according to this application. The apparatus may include a one-to-one corresponding module for performing the method/operation/step/action described in any one of the embodiments shown in FIG. 4 to FIG. 14. The module may be a hardware circuit, or may be software, or may be implemented by a hardware circuit in combination with software.

The apparatus 2000 includes a communication unit 2001 and a processing unit 2002, configured to implement the method performed by each device in the foregoing embodiments.

In a possible implementation, the apparatus is a network device, or is located in a network device. Further, the processing unit 2002 is configured to determine a frequency domain position and a transmit antenna port of a reference signal based on a channel noise constraint condition. The communication unit 2001 is configured to send first indication information, where the first indication information indicates the frequency domain position and the transmit antenna port of the reference signal.

For specific execution procedures of the communication unit 2001 and the processing unit 2002 in this implementation, refer to descriptions of steps performed by the first apparatus in the foregoing method embodiments and corresponding descriptions in the summary. Details are not described herein again. According to the communication method implemented by the apparatus, the frequency domain position and the transmit antenna port of the reference signal may be determined based on the channel noise constraint condition, so that a position of the reference signal follows specific regularity, to help reduce indication overheads of the reference signal. The first apparatus indicates the frequency domain position and the transmit antenna port of the reference signal, to help reduce overheads of a sounding reference signal for channel estimation, reduce a measurement delay, and improve accuracy of the channel estimation.

In another possible implementation, the apparatus is a terminal device, or is located in a terminal device. Further, the communication unit 2001 is configured to receive first indication information, where the first indication information indicates a frequency domain position and a transmit antenna port of a reference signal. The processing unit is configured to determine the frequency domain position and the transmit antenna port of the reference signal based on the first indication information, where the frequency domain position and the transmit antenna port of the reference signal are associated with a channel noise constraint condition.

For specific execution procedures of the communication unit 2001 and the processing unit 2002 in this implementation, refer to descriptions of steps performed by the second apparatus in the foregoing method embodiments and corresponding descriptions in the summary. Details are not described herein again. According to the communication method implemented by the apparatus, the frequency domain position and the transmit antenna port of the reference signal may be determined based on the first indication information, to help reduce overheads of a sounding reference signal for channel estimation, reduce a measurement delay, and improve accuracy of the channel estimation.

FIG. 21 is a diagram of another communication apparatus according to this application. The communication apparatus is configured to implement the communication method in the foregoing method embodiments. It may be understood that the communication apparatus 2100 includes necessary forms, such as modules, units, elements, circuits, or interfaces, and the necessary forms included in the communication apparatus 2100 are properly configured together to perform the method in this application. For example, the communication apparatus 2100 may be a RAN node, a terminal, a core network device, or another network device, or may be a part (for example, a chip) in these devices, and is configured to implement the method described in the foregoing method embodiments. The communication apparatus 2100 includes one or more processors 2101. The processor 2101 may be a general-purpose processor, a special-purpose processor, or the like. For example, the processor 2101 may be a baseband processor or a central processing unit. The baseband processor may be configured to process a communication protocol and communication data. The central processing unit may be configured to: control the communication apparatus (for example, a RAN node, a terminal, or a chip), execute a software program, and process data of the software program.

Optionally, the processor 2101 may include a program 2102 (which may also be referred to as code or instructions sometimes). The program 2102 may be run on the processor 2101, so that the communication apparatus 2100 performs the method described in the foregoing embodiments. In another possible design, the communication apparatus 2100 includes a circuit (not shown in FIG. 21), and the circuit is configured to implement a function of the first apparatus or the second apparatus in the foregoing embodiment.

Optionally, the communication apparatus 2100 may include one or more memories 2103, and the memory 2103 stores a program 2104 (which may also be referred to as code or instructions sometimes). The program 2104 may be run on the processor 2101, so that the communication apparatus 2100 performs the method described in the foregoing method embodiments.

Optionally, the processor 2101 and/or the memory 2103 may include artificial intelligence (AI) modules 2105 and 2106. The AI module is configured to implement an AI-related function. The AI module may be implemented by using software, hardware, or a combination of the software and the hardware. For example, the AI module may include a radio intelligence controller (RIC) module. For example, the AI module may be a near-real-time RIC or a non-real-time RIC.

Optionally, the communication apparatus 2100 further includes a transceiver 2107 and an antenna 2108. The transceiver 2107 and the antenna 2108 can implement receiving and sending functions, for example, communicate with another device via a transmission medium, so that the communication apparatus 2100 can communicate with another device.

In a possible implementation, the apparatus is a network device, or is located in a network device. Further, the processor 2101 is configured to determine a frequency domain position and a transmit antenna port of a reference signal based on a channel noise constraint condition. The transceiver 2107 and the antenna 2108 are further configured to send first indication information, where the first indication information indicates the frequency domain position and the transmit antenna port of the reference signal.

For a specific execution procedure of the communication apparatus 2100 in this implementation, refer to descriptions of steps performed by the first apparatus in the foregoing method embodiments and corresponding descriptions in the summary. Details are not described herein again. According to the communication method implemented by the apparatus, the frequency domain position and the transmit antenna port of the reference signal may be determined based on the channel noise constraint condition, so that a position of the reference signal follows specific regularity, to help reduce indication overheads of the reference signal. The first apparatus indicates the frequency domain position and the transmit antenna port of the reference signal, to help reduce overheads of a sounding reference signal for channel estimation, reduce a measurement delay, and improve accuracy of the channel estimation.

In a possible implementation, the apparatus is a terminal device, or is located in a terminal device. Further, the transceiver 2107 and the antenna 2108 are configured to receive first indication information, where the first indication information indicates a frequency domain position and a transmit antenna port of a reference signal. The processor 2101 is configured to determine the frequency domain position and the transmit antenna port of the reference signal based on the first indication information, where the frequency domain position and the transmit antenna port of the reference signal are associated with a channel noise constraint condition.

For a specific execution procedure of the communication apparatus 2100 in this implementation, refer to descriptions of steps performed by the second apparatus in the foregoing method embodiments and corresponding descriptions in the summary. Details are not described herein again. According to the communication method implemented by the apparatus, the frequency domain position and the transmit antenna port of the reference signal may be determined based on the first indication information, to help reduce overheads of a sounding reference signal for channel estimation, reduce a measurement delay, and improve accuracy of the channel estimation.

In this application, the processor may be a general-purpose processor, a digital signal processor, an application-specific integrated circuit, a field programmable gate array or another programmable logic device, a discrete gate or transistor logic device, or a discrete hardware component, and may implement or perform methods, steps, and logical block diagrams that are disclosed in this application. The general-purpose processor may be a microprocessor or any processor or the like. The steps of the methods disclosed with reference to this application may be directly implemented by a hardware processor, or may be implemented by a combination of hardware and a software module in a processor.

In this application, the memory may be a non-volatile memory, for example, a hard disk drive (HDD) or a solid-state drive (SSD), or may be a volatile memory, for example, a random-access memory (RAM). The memory is any other medium that can carry or store expected program code in a form of an instruction or a data structure and that can be accessed by a computer, but is not limited thereto. The memory in this application may alternatively be a circuit or any other apparatus that can implement a storage function, and is configured to store the program instructions and/or the data.

This application provides another communication apparatus. The device includes a processor and an interface. Optionally, the apparatus further includes a memory. The processor is coupled to the memory. The processor is configured to read and execute computer instructions stored in the memory, to implement the communication method in embodiments shown in FIG. 4 to FIG. 14.

This application provides a communication system. The communication system includes one or more of the devices in the embodiments shown in FIG. 4 to FIG. 14.

This application provides a computer-readable storage medium. The computer-readable storage medium stores a program or instructions. When the program or the instructions are run on a computer, the computer is enabled to perform the communication method in the embodiments shown in FIG. 4 to FIG. 14.

This application provides a computer program product. The computer program product includes instructions. When the instructions are run on a computer, the computer is enabled to perform the communication method in the embodiments shown in FIG. 4 to FIG. 14.

This application provides a chip or a chip system. The chip or the chip system includes at least one processor and an interface. The interface and the at least one processor are interconnected via a line. The at least one processor is configured to run a computer program or instructions, to perform the communication method in the embodiments shown in FIG. 4 to FIG. 14.

The interface in the chip may be an input/output interface, a pin, a circuit, or the like.

The chip system may be a system on chip (SOC), or may be a baseband chip, or the like. The baseband chip may include a processor, a channel encoder, a digital signal processor, a modem, an interface module, and the like.

In an implementation, the chip or the chip system described above in this application further includes at least one memory, and the at least one memory stores instructions. The memory may be a storage unit inside the chip, for example, a register or a cache, or may be a storage unit (for example, a read-only memory or a RAM) of the chip.

All or some of the technical solutions provided in this application may be implemented by using software, hardware, firmware, or any combination thereof. When software is used to implement the embodiments, all or a part of the embodiments may be implemented in a form of a computer program product. The computer program product includes one or more computer instructions. When the computer program instructions are loaded and executed on the computer, the procedure or functions according to this application are all or partially generated. The computer may be a general-purpose computer, a special-purpose computer, a computer network, a network device, a terminal device, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by the computer, or a data storage device (for example, a server or a data center) that integrates one or more usable media. The usable medium may be a magnetic medium (for example, a floppy disk, a hard disk drive, or a magnetic tape), an optical medium (for example, a DIGITAL VERSATILE DISC (DVD)), a semiconductor medium, or the like.

In this application, without a logical contradiction, mutual reference can be made between embodiments. For example, mutual reference can be made between methods and/or terms in method embodiments, mutual reference can be made between functions and/or terms in apparatus embodiments, and mutual reference can be made between functions and/or terms in the apparatus embodiments and the method embodiments.

It is clear that a person skilled in the art can make various modifications and variations to this application without departing from the scope of this application. This application is intended to cover these modifications and variations of this application provided that they fall within the scope of protection defined by the following claims and their equivalent technologies.

1. A method comprising:
determining, based on a channel noise constraint condition, a frequency-domain position and a transmit antenna port of a reference signal; and
sending first indication information,
wherein the first indication information indicates the frequency-domain position and the transmit antenna port, and
wherein the first indication information comprises a position of a frequency-domain subcarrier or a first index of the transmit antenna port.

2. The method of claim 1, wherein the channel noise constraint condition comprises a minimized channel noise-based reference signal selection criterion.

3. The method of claim 2, wherein the channel noise constraint condition further comprises a termination threshold that satisfies a minimum signal-to-noise ratio.

4. The method of claim 1, wherein the channel noise constraint condition comprises one or more of a first quantity of receive antennas, a second quantity of frequency-domain subcarriers, a power of a transmit end, a noise power of a channel, or a lower limit of a received signal-to-noise ratio.

5. The method of claim 1, wherein frequency-domain positions of the reference signal are partially continuous in either a system bandwidth or a bandwidth part (BWP) of a terminal device, and wherein transmit antenna ports of the reference signal are partially continuous in a set comprising all transmit antenna ports.

6. The method of claim 1, wherein all frequency-domain positions of the reference signal correspond to a same transmit antenna port.

7. The method of claim 1, wherein some frequency-domain positions of the reference signal correspond to a same transmit antenna port.

8. The method of claim 1, wherein sending the first indication information comprises sending a second index of a first column vector of a second matrix in a first matrix or a third matrix, wherein the first matrix comprises a first part of frequency-domain positions in a system bandwidth, a second part of transmit antenna ports, and all receive antenna ports, wherein the first part and the second part are based on a minimized channel noise and the third matrix, wherein the first column vector comprises the frequency-domain position and the transmit antenna port, wherein the frequency-domain position and the transmit antenna port are based on the channel noise constraint condition and the first matrix, wherein the third matrix comprises all the transmit antenna ports, all the receive antenna ports, and all the frequency-domain positions, and wherein a second column vector of the third matrix comprises a combination of the transmit antenna port, all the receive antenna ports, and all the frequency-domain positions.

9. The method of claim 1, wherein sending the first indication information comprises sending a rule of a reference signal pattern.

10. The method of claim 9, wherein the rule comprises one or more of a first position of the reference signal pattern on the frequency-domain subcarrier and the transmit antenna port, a spacing between frequency-domain subcarriers in the reference signal pattern, an interval between transmit antenna ports in the reference signal pattern, a first quantity of the frequency-domain subcarriers, or a second quantity of the transmit antenna ports.

11. The method of claim 9, wherein the rule comprises a first position of the reference signal pattern on the frequency-domain subcarrier and the transmit antenna port, and/or comprises a second index of another reference signal position in the reference signal pattern.

12. The method of claim 1, wherein the first indication information comprises the position of the frequency-domain subcarrier and the first index of the transmit antenna port.

13. The method of claim 12, wherein sending the first indication information comprises:
sending a combination that is of the frequency-domain position and a transmit antenna port position and that corresponds to a second index of a first column vector of a second matrix in a first matrix or a third matrix; or
sending all frequency-domain positions and all transmit antenna ports that correspond to the second index,
wherein the first matrix comprises a first part of frequency-domain positions in a system bandwidth, a second part of transmit antenna ports, and all receive antenna ports,
wherein the first part and the second part are based on a minimized channel noise and the third matrix,
wherein the first column vector comprises the frequency-domain position and the transmit antenna port,
wherein the frequency-domain position and the transmit antenna port are based on the channel noise constraint condition and the first matrix,
wherein the third matrix comprises all the transmit antenna ports, all the receive antenna ports, and all the frequency-domain positions, and
wherein a second column vector of the third matrix comprises a combination of the transmit antenna port, all the receive antenna ports, and all the frequency-domain positions.

14. The method of claim 13, further comprising sending second indication information indicating the frequency-domain position, a third index that is not for sending the reference signal, and/or a third index of the transmit antenna port that is not for sending the reference signal.

15. The method of claim 1, further comprising:
sending the reference signal at the frequency-domain position through the transmit antenna port; or
receiving, at the frequency-domain position, the reference signal from the transmit antenna port.

16. The method of claim 1, further comprising:
selecting, from a third matrix, a first initial column vector that satisfies a maximized trace of an antenna port-frequency-domain orthogonal basis matrix;
sequentially selecting, from the third matrix, second column vectors that satisfy the channel noise constraint condition to obtain selected second column vectors;
combining each of the selected second column vectors with the first initial column vector to obtain a fourth matrix, wherein a column vector dimension of the fourth matrix satisfies a preset maximum expected carrier quantity and a transmit antenna port quantity;
determining the frequency-domain position and a transmit antenna port position that correspond to a second index of each column vector of the fourth matrix in the third matrix;
combining the frequency-domain position, the transmit antenna port, and all receive antenna ports to obtain a first matrix;
sequentially selecting, from the first matrix, fourth column vectors of a minimized channel noise to obtain selected fourth column vectors; and
combining each of the selected fourth column vectors with the fourth matrix to obtain a second matrix, wherein a column vector dimension of the second matrix satisfies a rank of the third matrix and satisfies the channel noise constraint condition.

17. The method of claim 1, further comprising:
determining first column vectors corresponding to the transmit antenna port and the frequency-domain position that satisfy a preset reference signal pattern limitation condition, and all receive antenna ports to form a first matrix, wherein the preset reference signal pattern limitation condition comprises one or more of an interval between transmit antenna ports, a spacing between frequency-domain subcarriers, a maximum quantity of the transmit antenna ports, or a maximum quantity of the frequency-domain subcarriers;
selecting, from the first matrix, a second initial column vector that satisfies a maximized trace of an antenna port-frequency domain orthogonal basis matrix;
sequentially selecting, from the first matrix, third column vectors that satisfy the channel noise constraint condition to obtain selected third column vectors; and
combining each of the selected third column vectors with the second initial column vector to obtain a second matrix, wherein a column vector dimension of the second matrix satisfies a rank of a third matrix and satisfies the channel noise constraint condition.

18. An apparatus comprising:
a memory configured to store instructions; and
one or more processors coupled to the memory, wherein when executed by the one or more processors, the instructions cause the apparatus to:
determine, based on a channel noise constraint condition, a frequency-domain position and a transmit antenna port of a reference signal; and
send first indication information,
wherein the first indication information indicates the frequency-domain position and the transmit antenna port, and
wherein the first indication information comprises a position of a frequency-domain subcarrier or a first index of the transmit antenna port.

19. The apparatus of claim 18, wherein the channel noise constraint condition comprises a minimized channel noise-based reference signal selection criterion.

20. A computer program product comprising computer-executable instructions that are stored on a non-transitory computer-readable storage medium and that, when executed by one or more processors, cause an apparatus to:
determine, based on a channel noise constraint condition, a frequency-domain position and a transmit antenna port of a reference signal; and
send first indication information,
wherein the first indication information indicates the frequency-domain position and the transmit antenna port, and
wherein the first indication information comprises a position of a frequency-domain subcarrier or a first index of the transmit antenna port.
